(19) United States
(12) Patent Application Publication
(10) Pub. No.: US 2022/0394098 A1
(43) Pub. Date: Dec. 8, 2022

(54) INFORMATION PROCESSING SYSTEM, SYSTEM, AND INFORMATION PROCESSING METHOD

(71) Applicant: Mitsuo ANDO, Fukuoka (JP)

(72) Inventor: Mitsuo ANDO, Fukuoka (JP)

(21) Appl. No.: 17/829,407

(22) Filed: Jun. 1, 2022

(30) Foreign Application Priority Data
Jun. 4, 2021 (JP) 2021-094177

(51) Int. Cl. H04L 67/141; G06K 7/14

(52) U.S. Cl. CPC H04L 67/141; G06K 7/1417

(57) ABSTRACT

An information processing system includes circuitry. The circuitry acquires a plurality of log information each including identification information identifying a touch point read by a user terminal and indicating a usage history of a particular service identified by the identification information, the log information including a plurality of log information. The circuitry estimates attribute information including a plurality of attribute items for identifying use of the particular service based on the plurality of log information. The circuitry generates a site profile indicating an action history at a site where the touch point is read based on the plurality of log information and the estimated attribute information.

### CROSS-REFERENCE TO RELATED APPLICATION

This patent application is based on and claims priority pursuant to 35 U.S.C. § 119(a) to Japanese Patent Application No. 2021-094177, filed on Jun. 4, 2021, in the Japan Patent Office, the entire disclosure of which is hereby incorporated by reference herein.

### BACKGROUND

### Technical Field

Embodiments of the present disclosure relate to an information processing system, a system, and an information processing method.

### Related Art

A cloud service is known in the art that allows a user to easily use a service registered in advance by reading, with a device such as a smartphone, a QR Code® or a tag identifier (ID) installed in a device or a room or embedded online.

For example, a system is known in which a smartphone transmits an ID read from a tag or a QR Code® and a user ID to a server, and the server provides a service associated with a combination of the ID and the user ID to a user or a device.

### SUMMARY

An embodiment of the present disclosure includes an information processing system including circuitry. The circuitry acquires a plurality of log information each including identification information identifying a touch point read by a user terminal and indicating a usage history of a particular service identified by the identification information, the log information including a plurality of log information. The circuitry estimates attribute information including a plurality of attribute items for identifying use of the particular service based on the plurality of log information. The circuitry generates a site profile indicating an action history at a site where the touch point is read based on the plurality of log information and the estimated attribute information.

Another embodiment of the present disclosure includes a system including an information processing system including information processing system circuitry, and a user terminal including user terminal circuitry. The user terminal circuitry reads the touch point. The user terminal circuitry transmits, to the information processing system, information acquired by reading the touch point. The information processing system circuitry acquires a plurality of log information each including identification information identifying a touch point read by a user terminal and indicating a usage history of a particular service identified by the identification information, the log information including a plurality of log information. The information processing system circuitry estimates attribute information including a plurality of attribute items for identifying use of the particular service based on the plurality of log information. The information processing system circuitry generates a site profile indicating an action history at a site where the touch point is read based on the plurality of log information and the estimated attribute information. The information processing system circuitry provides to the user terminal the particular service corresponding to the information acquired by reading the touch point.

Another embodiment of the present disclosure includes an information processing method performed by an information processing system. The method includes acquiring a plurality of log information each including identification information identifying a touch point read by a user terminal and indicating a usage history of a particular service identified by the identification information, the log information including a plurality of log information. The method includes estimating attribute information including a plurality of attribute items for identifying use of the particular service based on the plurality of log information. The method includes generating a site profile indicating an action history at a site where the touch point is read based on the acquired log information and the estimated attribute information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overall configuration of a service use system, according to an embodiment of the present disclosure;

FIG. 2 is a schematic diagram illustrating an example of an operation performed by the service use system, according to an embodiment of the present disclosure;

FIG. 3 is a schematic diagram of an example of integration of data based on a touch point that is read, according to an embodiment of the present disclosure;

FIG. 4 is a diagram illustrating an example of an overview of an action history in which a touch point that is read is set as a starting point, according to an embodiment of the present disclosure;

FIG. 5 is a diagram illustrating an example of an overview of a site profile generated based on a touch point that is read, according to an embodiment of the present disclosure;

FIG. 6A to FIG. 6D are diagrams illustrating examples of types of a service provided by a coordination service, according to an embodiment of the present disclosure;

FIG. 7 is a block diagram illustrating an example of a hardware configuration of an information processing system, according to an embodiment of the present disclosure;

FIG. 8 is a diagram illustrating an example of a hardware configuration of each of a user terminal and an administrator terminal, according to an embodiment of the present disclosure;

FIG. 9 is a block diagram illustrating an example of a functional configuration of the service use system, according to an embodiment of the present disclosure;

FIG. 10 is a conceptual diagram illustrating an example of a coordination service management table, according to an embodiment of the present disclosure;

FIG. 11 is a conceptual diagram illustrating an example of a touch point management table, according to an embodiment of the present disclosure;

FIG. 12 is a conceptual diagram illustrating an example of a log information management table, according to an embodiment of the present disclosure;

FIG. 13 is a flowchart illustrating an example of an operation of constructing a profile by the service use system, according to an embodiment of the present disclosure;

FIG. 14 is a sequence diagram illustrating an example of an operation of using a service by using the user terminal, according to an embodiment of the present disclosure;

FIG. 15 is a sequence diagram illustrating an example of an operation of using a service by using the user terminal, according to an embodiment of the present disclosure;

FIG. 16 is a flowchart illustrating an example of an operation of generating of a site profile by the information processing system, according to an embodiment of the present disclosure;

FIG. 17 is a conceptual diagram illustrating an example of an attribute information management table, according to an embodiment of the present disclosure;

FIG. 18 is a conceptual diagram illustrating an example of a site profile management table, according to an embodiment of the present disclosure;

FIG. 19 is a diagram for describing an overview of an example of an action history in which a teacher A is set as a starting point, according to an embodiment of the present disclosure;

FIG. 20 is a diagram for describing an overview of an example of an action history in which the teacher A is set as a starting point, according to an embodiment of the present disclosure;

FIG. 21 is a diagram for describing an overview of an example of a site profile generated with the teacher A as a starting point, according to an embodiment of the present disclosure;

FIG. 22 is a diagram for describing an overview of an example of a user profile generated with the teacher A as a starting point, according to an embodiment of the present disclosure;

FIG. 23 is a diagram illustrating an example of user context information, according to an embodiment of the present disclosure;

FIG. 24 is a conceptual diagram illustrating an example of a user profile management table, according to an embodiment of the present disclosure; and

FIG. 25 is a diagram for describing an overview of an example of a course period profile in which the teacher A is set as a starting point, according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described with reference to the drawings. In the description of the drawings, the same elements are denoted by the same reference numerals, and redundant descriptions thereof are omitted.

### Embodiments

System Configuration:

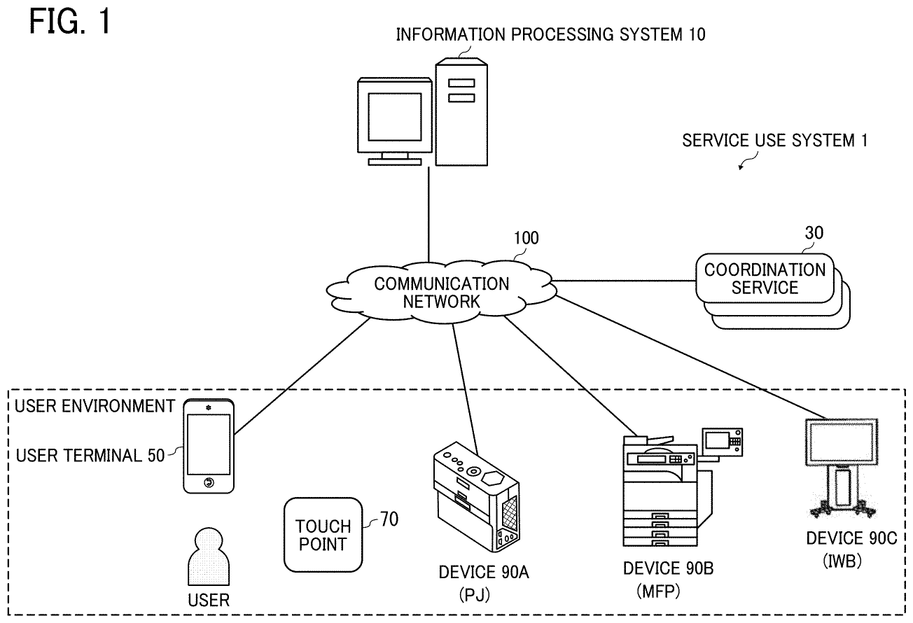

FIG. 1 is a schematic diagram illustrating an example of an overall configuration of a service use system 1. The service use system 1 illustrated in FIG. 1 is a system in which a user terminal 50 reads a touch point 70 installed in a predetermined user environment, and thereby various coordination services 30 are available to a user via an information processing system 10.

The service use system 1 includes the information processing system 10, the user terminal 50, and a device 90. The information processing system 10, the user terminal 50, and the device 90 of the service use system 1 communicate with each other through a communication network 100. The communication network 100 includes the Internet, a mobile communication network, and a local area network (LAN), for example. The communication network 100 may include, in addition to a wired network, a wireless network in compliance with such as 3rd Generation (3G), 4th Generation (4G), 5th Generation (5G), Wireless Fidelity® (Wi-Fi), Worldwide Interoperability for Microwave Access (WiMAX), and Long Term Evolution (LTE).

The service use system 1 provides various types of services to a user by connecting the coordination service 30, which provides the various types of services via the information processing system 10, to the user terminal 50 or the device 90.

The information processing system 10 is a server computer that executes processing for providing a predetermined service to a user who uses the user terminal 50 by cooperating with the coordination service 30. The information processing system 10 may be implemented by a single server computer or may be implemented by a plurality of server computers. In the following, a description is given of an example in which the information processing system 10 is a server computer that resides in a cloud environment. In another example, the information processing system 10 may be a server that resides in an on-premises environment. In some embodiments, the information processing system 10 may provide a service to a user by cooperating with the coordination service 30 that is externally operated by a different administrator or may be configured by a service providing company that provides a series of services including the coordination service 30. The information processing system 10 may be a device having a server function installed in a user environment.

The user terminal 50 is a computer such as a smartphone used by a user. The user terminal 50 reads the touch point 70 provided in the user environment to use a predetermined service installed from the coordination service 30. The smartphone is merely one example of the user terminal 50. In another example, the user terminal 50 may be a laptop computer, a tablet terminal, a wearable terminal, or a smartwatch.

In the disclosure, the touch point 70 is a contact between the user terminal 50 carried by the user and a particular service, for providing the particular service to the user. The user terminal 50 reads the touch point 70 to acquire information for accessing the particular service. The service is provided to the user via the information processing system 10, such as a server computer or a device. The touch point 70, which is a contact, is implemented by, for example, an image, an information medium, or a communication device that provide information. Specifically, the touch point 70 is implemented by, for example, an image such as a two-dimensional code including a QR Code®, an information medium that reads information using short-range communications such as a near field communication (NFC) tag or a radio frequency identification (RFID) tag, or a communication device that transmits information using short-range wireless communication network such as Bluetooth® or ultrasonic waves. The image of the two-dimensional code may be printed on a paper medium or may be displayed on a display device such as a display.

The devices 90 (device 90A, device 90B, and device 90C) are installed in a user environment and cooperate with the user terminal 50, to use various services provided by the coordination service 30. Examples of the devices 90 include, but are not limited to, a projector (PJ), a multifunction peripheral (MFP), a printer, an interactive whiteboard (IWB), a personal computer (PC), a lighting fixture, an air conditioner, an image capturing device, and a robot.

Overview:

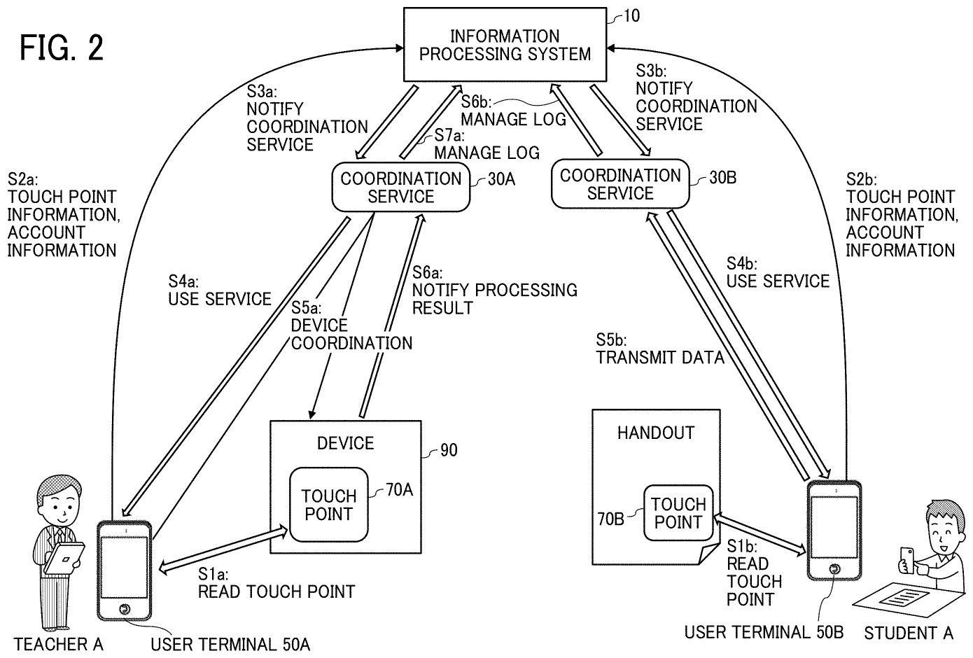

Referring to FIG. 2 to FIG. 6, an overview of an operation performed by the service use system 1 is described. FIG. 2 is a schematic diagram illustrating an example of an operation performed by the service use system 1. FIG. 2 illustrates an example in which each user reads the touch point 70 to user a predetermined service in a school, which is an example of the user environment. FIG. 2 is a drawing for describing an overview of the operation performed by the service use system 1. A detailed description of functions implemented by the service use system 1 is given below with reference to other drawings.

First, for example, a teacher A who gives a lecture at the school reads a touch point 70A attached to the device 90 with a user terminal 50A that the teacher A uses (step S1a). The user terminal 50A transmits information on the read touch point and an account information of a user (the teacher A) who uses the user terminal 50A to the information processing system 10 (step S2a). The information on the read touch point may be referred to hereinafter “touch point information”. The information processing system 10 notifies a device coordination service 30A, which is an example of the coordination service 30, corresponding to the touch point information received from the user terminal 50A of the account information of the user (step S3a). Then, the user terminal 50A starts using a service provided by the device coordination service 30A (step S4a). The user terminal 50A performs, via the device coordination service 30A, device coordination with the device 90 using the service (in this case, a device coordination service) provided by the device coordination service 30A (step S5a). The communication between the device coordination service 30A and the device 90 may be performed via a relay device such as a gateway. The device 90 executes processing corresponding to the request transmitted from the user terminal 50, and transmits a notification indicating a processing result to the device coordination service 30A (step S6a). Then, the device coordination service 30A transmits log information indicating a usage history of the service used by the user including the received processing result to the information processing system 10, and the information processing system 10 accumulates and manages the received log information (step S7a).

On the other hand, for example, a student A, who attends a lecture at the school reads a touch point 70B attached to a distributed handout, for example, using a user terminal 50B that the student B uses (step S1b). The user terminal 50B transmits the read touch point information and an account information of a user (the student B) who uses the user terminal 50B to the information processing system 10 (step S2b). The information processing system 10 notifies a data submission service 30B, which is an example of the coordination service 30, corresponding to the touch point information received from the user terminal 50B of the account information of the user (step S3b). Then, the user terminal 50B starts using a service provided by the data submission service 30B (step S4b). The user terminal 50B transmits, to the data submission service 30B, a data file such as an answer sheet by using a service (in this case, data submission service) provided by the data submission service 30B (step S5b). The data submission service 30B executes processing corresponding to the request transmitted from the user terminal 50B, and transmits log information indicating a usage history of the service used by the user including the processing result to the information processing system 10. The information processing system 10 accumulates and manages the received log information (step S6b).

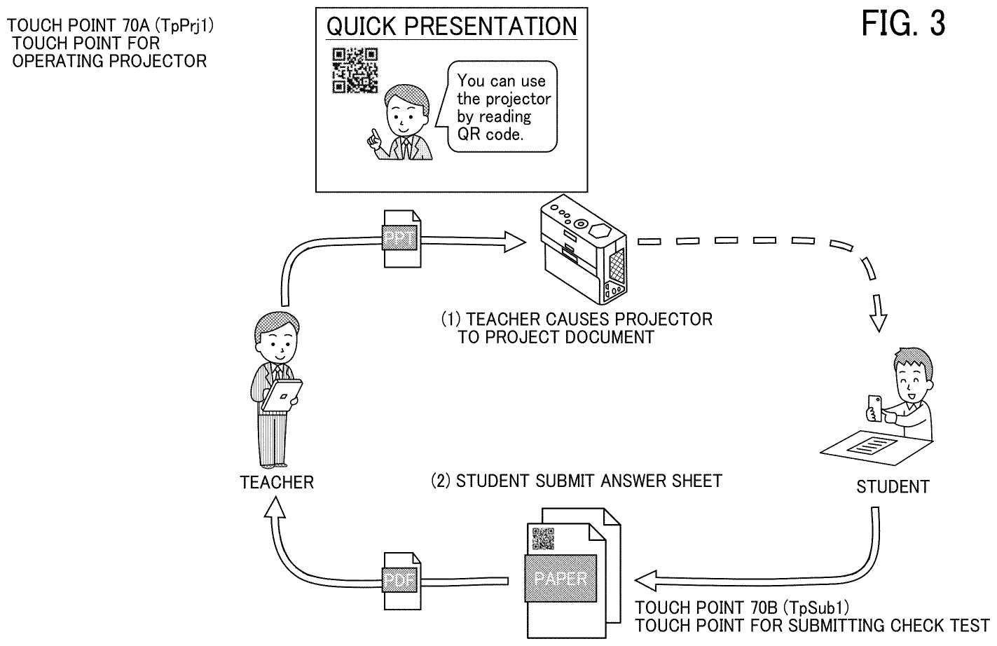

Referring to FIG. 3 to FIG. 5, a description is given of generating a site profile including action histories of multiple users by using multiple log information accumulated in the information processing system 10. FIG. 3 is a schematic diagram of an example of integration of data based on a touch point that is read. At a site in a user environment, there are many scenes where one cannot grasp all data exchanged between persons. This leads to insufficient recognition of the background of the site and actions of the persons to accurately recognize an action history of the site. In the example of FIG. 3, unless attendees of a lecture are registered, a person who viewed a lecture document displayed on a projector cannot be identified or a location where a student submitted an answer sheet cannot be identified. As described, the action history of the site includes many data transmitted directly from the device to a person or from a person to another person not though a cloud network, for example.

In other words, according to the conventional method, in digitization at a site, a connection between persons, positions and actions of persons at the site cannot be recognized. Further, data that is directly transmitted from the device 90 to a person or from a person to another person cannot be acquired. Accordingly, even if individual services are combined, the action history is fragmented, and data of log information cannot be integrated. In view of such an issue, the information processing system 10 integrates fragmented action histories at the site by using multiple touch points 70 provided in the site, to generate a site profile, which is an action history that integrates the entire site, thereby dealing with the issue of digitization of the site.

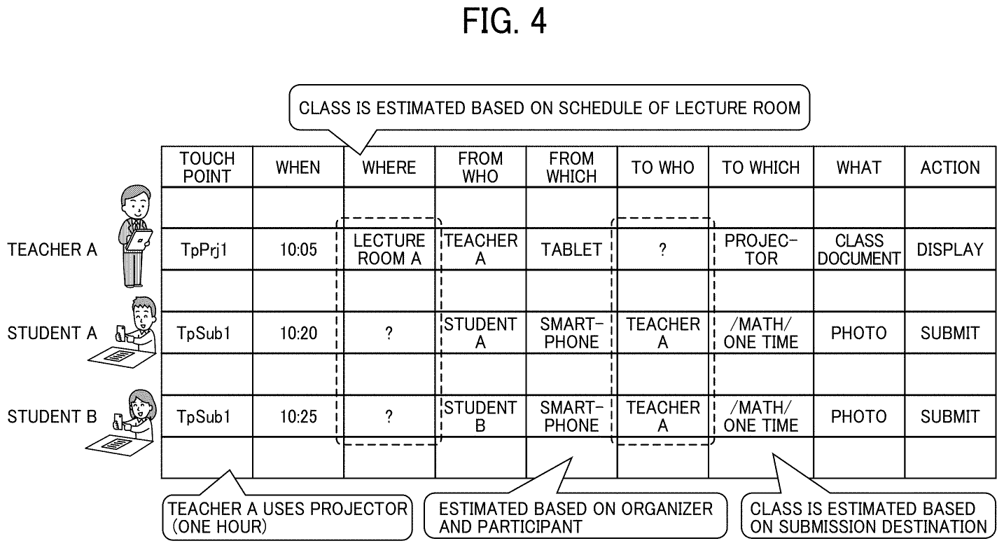

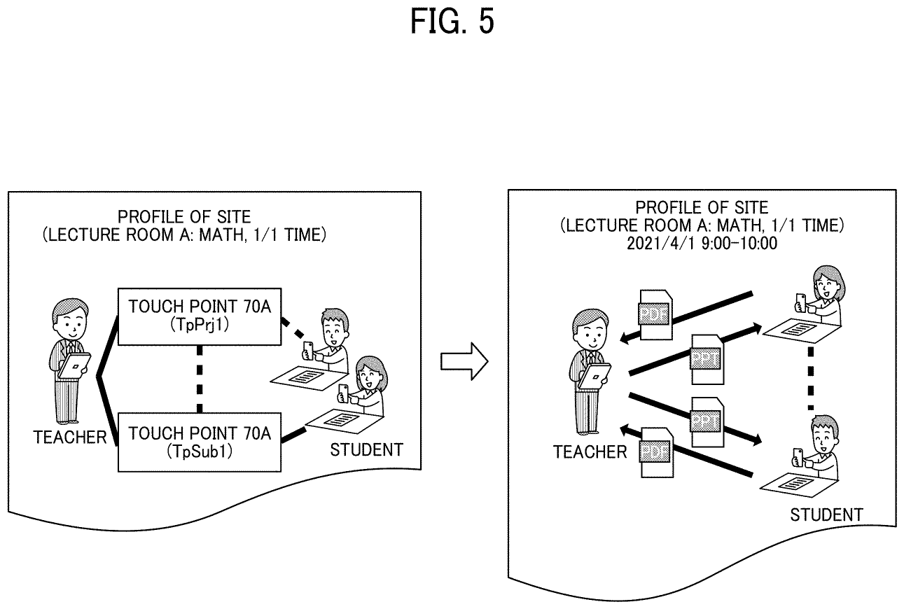

FIG. 4 is a diagram illustrating an example of an overview of an action history with a touch point that is read as a starting point. FIG. 5 is a diagram illustrating an example of an overview of a site profile generated based on a touch point that is read.

In a site, a user acts at various locations by utilizing the device 90 or a service associated with the touch point 70. The utilization of the touch point 70 (touch point ID) that associates a person with a service makes it easy to acquire an action history of “who did what and when”. However, it is often difficult to identify an action history of “where” in the site. Although the location can be identified with a global positioning system (GPS), the GPS is not generally used for identifying an indoor site or a site. Further, at a site, it is difficult to identify to “whom” a behavior such as “project” and “speak”. One has to grasp the site to identify the “whom”.

The touch point 70 is attached to the device 90 or the like at the site. For example, the touch point is attached to the device 90 that is nonportable or a location. In an alternative case, the touch point is attached to an answer sheet or the device 90 that is portable such as a portable projector. When the touch point 70 is portable, the information processing system 10 can register in the touch point 70 information identifying a location in advance. Examples of the information identifying a location include a lecture room A and a laboratory A. Even in a case that the information identifying a location is not registered in advance, the information processing system 10 stores information indicating immobile or nonportable, thereby identifying a location of the user in a case that a service via the touch point 70 is used. Further, when the same user uses different touch points 70 near the same time at the site, the information processing system 10 can estimate the location of the touch point 70 that is portable.

Further, when multiple users use a service via the touch point 70 in the same site, the information processing system 10 can recognize participants in the same site, and thus can estimate “who”. The estimation result of “where” is used to identify whether the multiple users use the service in the same site. Furthermore, the information processing system 10 associate a schedule of a user with the touch point 70, to generate a site profile as illustrated in FIG. 5.

Thus, the information processing system 10 generates the site profile indicating the action history in the site based on the usage history of the service via multiple touch points 70. In the conventional method, when one is going to use data of a usage history of various service, the one recognizes that the services are provided to a particular user or a particular device, but the one cannot recognize the relation between the services. For this reason, the one cannot recognize details of what kind of site the service is used. For example, in a case that a teacher causes a particular projector to display content and a student submits an assignment created while viewing the content projected by the projector, the two services are executed based on touch points read by different users, and thus the relation cannot be recognized.

In view of such an issue, the information processing system 10 estimates the relation between a plurality of different services based on a usage history of the services including information such as a service usage time and a service usage location, and generate the site profile by utilizing the usage history with the site as a starting point based on not only the usage history of the individual user but also the usage history of the plurality of users. The information processing system 10 grasps data and context of a site and integrates the data from the user's point of view, to visualize the data and context of the site, to predict the next site for supporting the user, and to find potential issues for making proposals according to the site. Thus, the information processing system 10 reduces or eliminates simple work in the site to support the user create creative value that only humans can achieve.

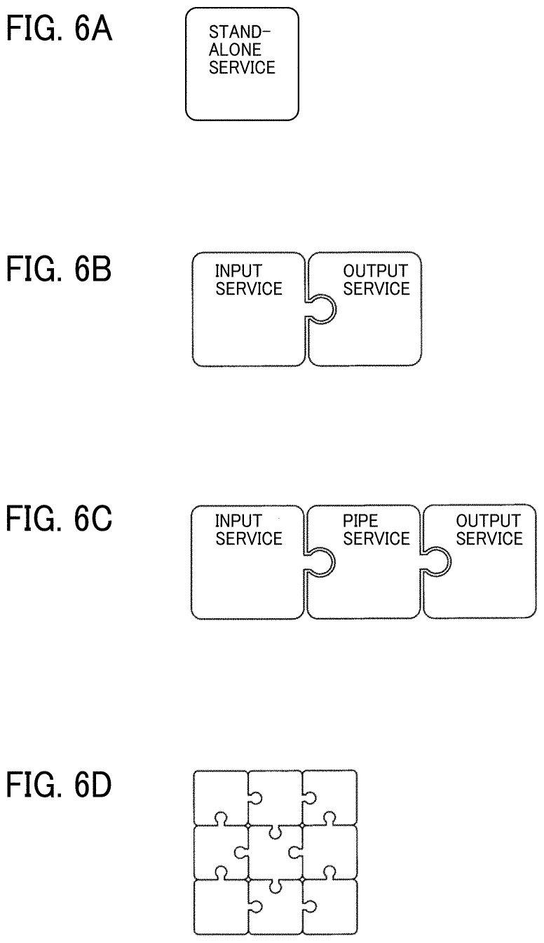

In the present embodiment, the “service” provided by the coordination service 30 is classified into the following types, for example. FIG. 6A to FIG. 6D are diagrams illustrating examples of the types of the service provided by the coordination service 30. FIG. 6A to FIG. 6D illustrates four types (1) to (4), respectively.

The service of the type (1) is a stand-alone service. The device 90 or software used in the stand-alone service is basically one type. Examples of the stand-alone service include a service in which the device 90 is a lighting device in a conference room or the like and light of the lighting device gets brighter when the touch point 70 is read by the user terminal 50.

The service of the type (2) is a combination of an input service and an output service. The input service is a service for inputting or acquiring data to be processed by the service by using software or the device 90. The output service is a service for outputting or storing data to be processed by the service by using software or the device 90.

The service of the type (3) is a service in which a pipe service is inserted between the input service and the output service. The pipe service refers to a service that processes or converts data to be processed by the service by using software or the device 90. Examples of the pipe service include optical character recognition (OCR) and translation.

The service of the type (4) is a service in which the input services, the pipe services, the output services, and the like are combined in a complex manner. For example, data input from a given input service is input to two or more pipe services or output services. In another example, a given output service outputs data that is input from two or more input services or two or more pipe services.

Hardware Configuration:

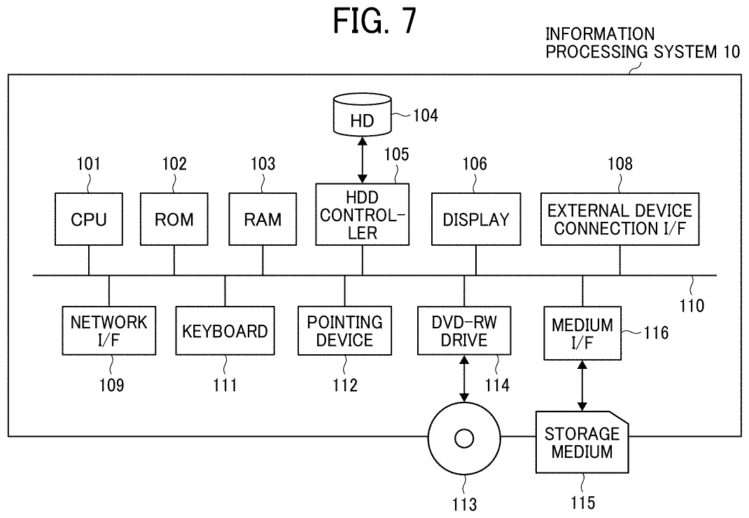

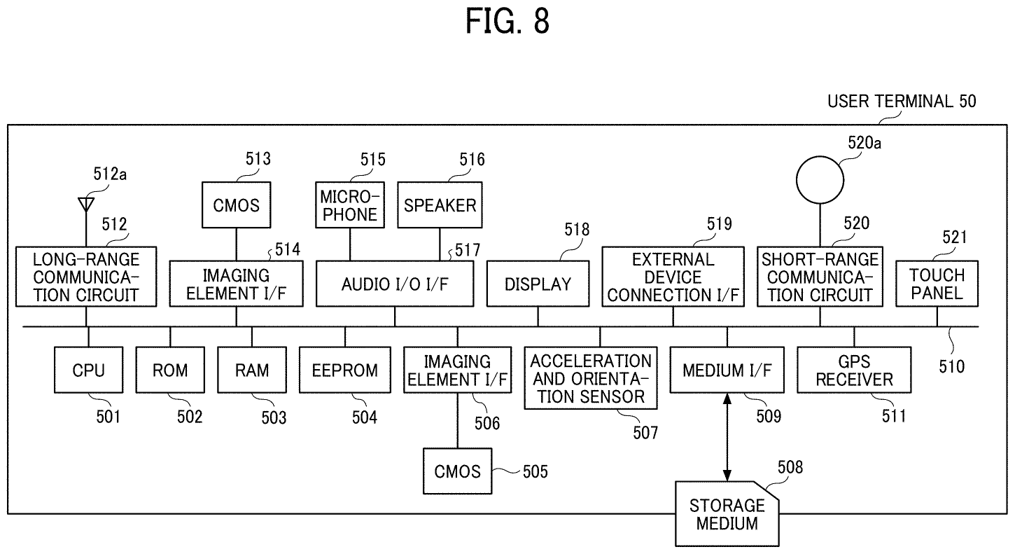

Referring to FIG. 7 and FIG. 8, a hardware configuration of an apparatus or a terminal included in the service use system is described according to the embodiment. Each hardware configuration of the apparatus or terminal illustrated in FIG. 7 or FIG. 8 may have elements added or deleted as needed.

Hardware Configuration of Information Processing System:

FIG. 7 is a block diagram illustrating an example of a hardware configuration of the information processing system 10. Each hardware element of the information processing system 10 is denoted by a reference numeral in 100 series. As illustrated in FIG. 7, the information processing system 10, which is implemented by a computer, includes a central processing unit (CPU) 101, a read only memory (ROM) 102, a random access memory (RAM) 103, a hard disk (HD) 104, a hard disk drive (HDD) controller 105, a display 106, an external device connection interface (I/F) 108, a network I/F 109, a bus line 110, a keyboard 111, a pointing device 112, a digital versatile disk rewritable (DVD-RW) drive 114, and a medium I/F 116.

The CPU 101 controls overall operation of the information processing system 10. The ROM 102 stores programs such as an initial program loader (IPL) to boot the CPU 101. The RAM 103 is used as a work area for the CPU 101. The HD 104 stores various data such as a program. The HDD controller 105 controls reading or writing of various data from or to the HD 104 under control of the CPU 101. The display 106 displays various information such as a cursor, a menu, a window, characters, or an image. In one example, the display 106 is a touch panel display provided with an input device. The external device connection I/F 108 is an interface that connects the computer (the information processing system 10) to various external devices. The network I/F 109 is an interface that controls communication of data with an external device through the communication network 100. The bus line 110 is, for example, an address bus or a data bus, which electrically connects the elements such as the CPU 101 illustrated in FIG. 7.

The keyboard 111 is an example of an input device including a plurality of keys for inputting characters, numerical values, or various instructions. The pointing device 112 is an example of an input device that allows a user to select or execute a specific instruction, select processing to be executed, or move a cursor being displayed. The keyboard 111 and the pointing device 112 are merely examples of the input device. As another example of the input device, a touch panel or a voice input device may be used. The DVD-RW drive 114 controls reading or writing of various data from or to a DVD-RW 113, which is an example of a removable storage medium. In another example, the removable storage medium includes at least one of digital versatile disk-recordable (DVD-R) or a Blu-ray® disc, in addition to or in alternative to the DVD-RW. The medium I/F 116 controls reading or writing (storing) of data with respect to a storage medium 115 such as a flash memory.

Hardware Configuration of User Terminal:

FIG. 8 is a block diagram illustrating an example of a hardware configuration of the user terminal 50. Each hardware element of the user terminal 50 is denoted by a reference numeral in 500 series. As illustrated in FIG. 8, the user terminal 50, which is implemented by a computer, includes a CPU 501, a ROM 502, a RAM 503, an electrically erasable PROM (EEPROM) 504, a complementary metal oxide semiconductor (CMOS) sensor 505, an imaging element I/F 506, an acceleration and orientation sensor 507, a medium I/F 509, and a GPS receiver 511.

The CPU 501 controls overall operation of the user terminal 50. The ROM 502 stores programs such as an initial program loader (IPL) to boot the CPU 501.

The RAM 503 is used as a work area for the CPU 501. The EEPROM 504 reads or writes various data such as a control program for the user terminal under control of the CPU 501. The CMOS sensor 505 is an example of a built-in imaging device that captures an object (mainly, a self-image of a user operating the user terminal 50) under control of the CPU 501 to obtain image data. In alternative to the CMOS sensor 505, an imaging element such as a charge-coupled device (CCD) sensor may be used. The imaging element I/F 506 is a circuit that controls driving of the CMOS sensor 505. Examples of the acceleration and orientation sensor 507 include various sensors such as an electromagnetic compass to detect geomagnetism, a gyrocompass, and an accelerometer. The medium I/F 509 controls reading or writing (storing) of data with respect to a storage medium 508 such as a flash memory. The GPS receiver 511 receives a GPS signal from a GPS satellite.

The user terminal 50 further includes a long-range communication circuit 512, a CMOS sensor 513, an imaging element I/F 514, a microphone 515, a speaker 516, an audio input/output I/F 517, a display 518, an external device connection I/F 519, a short-range communication circuit 520, an antenna 520a of the short-range communication circuit 520, and a touch panel 521.

The long-range communication circuit 512 is a circuit that enables the user terminal 50 to communicate with other devices through the communication network 100. The CMOS sensor 513 is an example of a built-in imaging device that captures an object under control of the CPU 501 to obtain image data. The imaging element I/F 514 is a circuit that controls driving of the CMOS sensor 513. The microphone 515 is a built-in circuit that converts sound into an electric signal. The speaker 516 is a built-in circuit that converts electric signals into physical vibrations to produce sounds such as music and voice. The audio input/output I/F 517 is a circuit for inputting or outputting audio signals to the microphone 515 or from the speaker 516 under control of the CPU 501. The display 518 is an example of a display device that displays an image of an object, various icons, etc. Examples of the display 518 include a liquid crystal display (LCD) and an organic electroluminescence (EL) display. The external device connection I/F 519 is an interface that connects the computer (the user terminal 50) to various external devices. The short-range communication circuit 520 is a communication circuit that communicates in compliance with the near field communication (NFC) or the Bluetooth®, for example. The touch panel 521 is an example of an input device that allows a user to operate the user terminal 50 by touching a screen of the display 518.

The user terminal 50 further includes a bus line 510. The bus line 510 is, for example, an address bus or a data bus, which electrically connects the elements illustrated in FIG. 8 such as the CPU 501 with one another.

For example, any one of the above-described control programs is recorded in a file in a format installable or executable on a computer-readable storage medium for distribution. Examples of the storage medium include, but are not limited to, a compact disc-recordable (CD-R), a digital versatile disk (DVD), a Blu-ray® disc, a secure digital (SD) card, and a universal serial bus (USB) memory. In addition, such storage medium may be provided in the domestic markets of foreign markets as program products. For example, the information processing system 10 implements an information processing method according to an embodiment of the present disclosure by executing a program according to an embodiment of the present disclosure.

Functional Configuration:

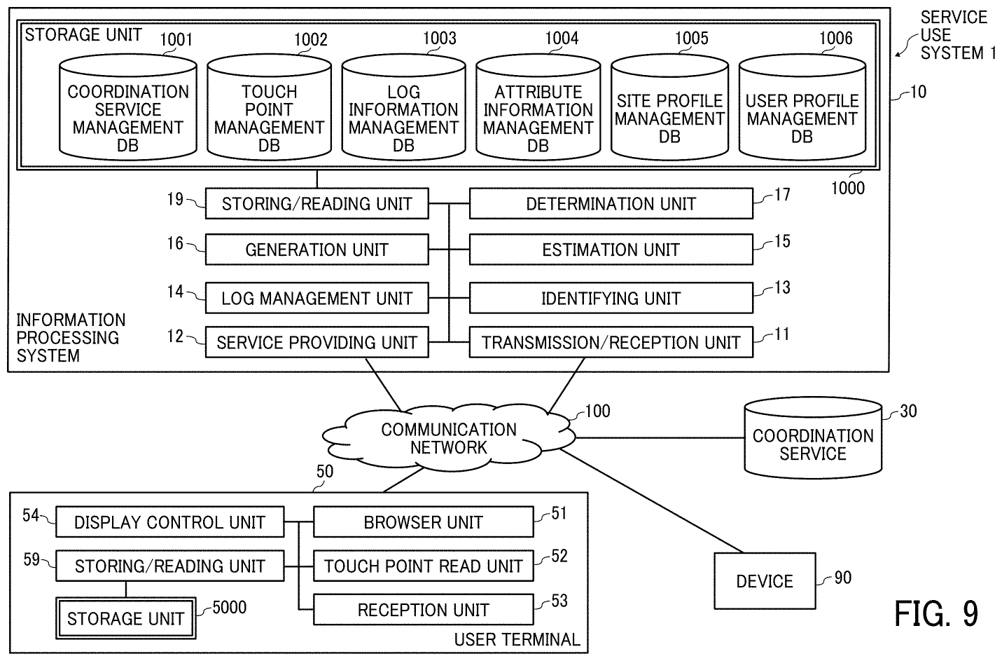

Referring to FIG. 9 to FIG. 12, a functional configuration of the service use system 1 is described according to an embodiment. FIG. 9 is a block diagram illustrating an example of a functional configuration of the service use system 1. FIG. 9 illustrates a part of apparatuses, devices, and terminals of FIG. 1, which are related to processing or operation to be described below.

Functional Configuration of Information Processing System:

Referring to FIG. 9, a functional configuration of the information processing system 10 is described. The information processing system 10 includes a transmission/reception unit 11, a service providing unit 12, an identifying unit 13, a log management unit 14, an estimation unit 15, a generation unit 16, a determination unit 17, and a storing/reading unit 19. These units are functions or means implemented by or that are caused to function by operating any of the hardware elements illustrated in FIG. 7 in cooperation with instructions of the CPU 101 according to the program for the information processing system 10 expanded to the RAM 103. The information processing system 10 further includes a storage unit 1000 implemented by the ROM 102, the HD 104, or the storage medium 115 illustrated in FIG. 7.

The transmission/reception unit 11 is mainly implemented by the network I/F 109 that operates according to instructions of the CPU 101. The transmission/reception unit 11 transmits or receives various data or information to or from other apparatuses or terminals through the communication network 100. The service providing unit 12, which is mainly implemented by processing of the CPU 101, provides the various types of services to the user terminal 50 through the touch point 70. The identifying unit 13, which is implemented by processing of the CPU 101, identifies the coordination service 30 to be provided to a user based on touch point information transmitted from the user terminal 50.

The log management unit 14, which is mainly implemented by processing of the CPU 101, manages log information indicating a usage history of a predetermined service. The estimation unit 15, which is implemented by processing of CPU 101, estimates attribute information including a plurality of attribute items for identifying the use of a predetermined service based on the log information managed by the log management unit 14. The attribute items include, for example, information of at least one of a user who has used the predetermined service, a usage time, a usage location, and a service content.

The generation unit 16, which is implemented by processing of the CPU 101, generates a site profile based on the touch point 70 based on a plurality of pieces of log information managed by the log management unit 14 and the attribute information estimated by the estimation unit 15. The determination unit 17, which is implemented by processing of the CPU 101, performs various determinations.

The storing/reading unit 19, which is mainly implemented by processing of the CPU 101, stores various data or information in the storage unit 1000 or reads various data or information from the storage unit 1000.

Coordination Service Management Table:

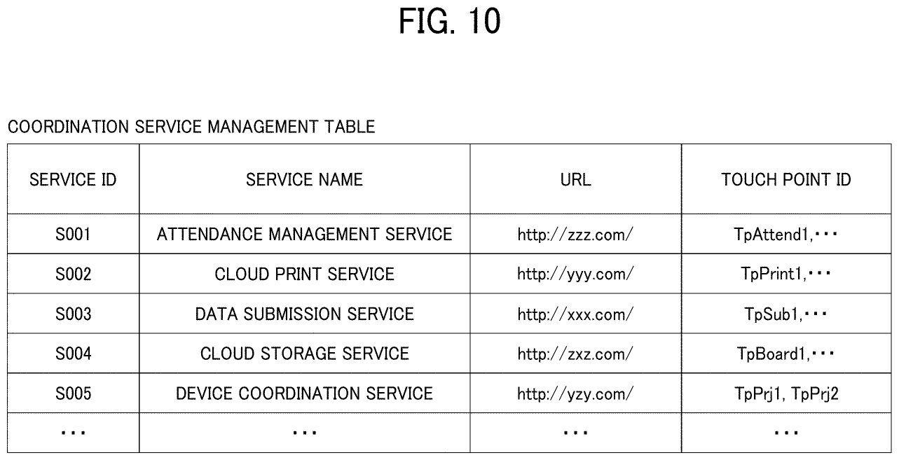

FIG. 10 is a conceptual diagram illustrating an example of a coordination service management table. The coordination service management table is a table for managing the coordination services 30 that are to be linked with the information processing system 10. In the storage unit 1000, a coordination service management database (DB) 1001 is stored, for example, in the form of the coordination service management table as illustrated in FIG. 10.

The coordination service management table manages coordination service information in which an information record includes information items of service ID, service name, a uniform resource locator (URL), and touch point ID that are associated with each other. The service ID and the service name identify the coordination service 30. The URL is for accessing the coordination service 30. The touch point ID identifies the touch point 70.

Touch Point Management Table:

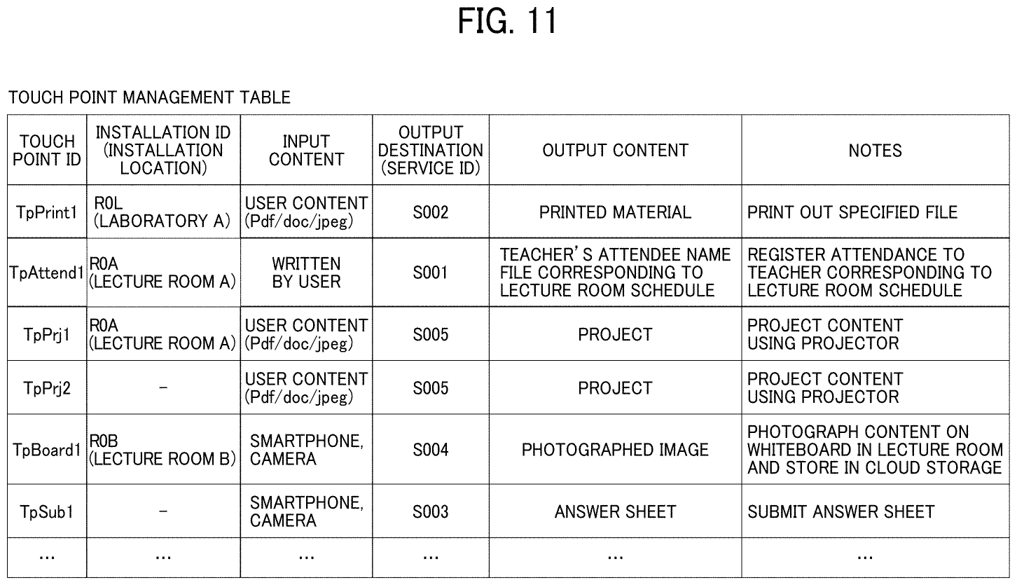

FIG. 11 is a conceptual diagram illustrating an example of a touch point management table. The touch point management table is a table for managing various information set for each touch point 70. In the storage unit 1000, a touch point management DB 1002 is stored, for example, in the form of the touch point management table as illustrated in FIG. 11.

The touch point management table manages a touch point ID, an installation ID, an input content, an output destination, and an output content, in association with each other. The touch point ID identifies the touch point 70. The installation ID identifies an installation location where the touch point 70 is installed. The input content indicates content that is input to a service to be used. The output destination is provided by a service to be used. The output content indicates an output of a service to be used.

The touch point ID is an example of identification information of the touch point 70 that associates a user who has read the touch point 70 with the coordination service 30. Different alphanumeric values are allocated respectively to the coordination services 30. In the disclosure, a description is given of an example in which the touch point ID includes alphanumeric characters from which a meaning is guessed so that the touch point IDs are easily distinguished from one to another. Alternatively, the touch point ID may be a random numerical value. The installation ID is set to the touch point 70 that is nonportable, and the same installation ID is assigned to the touch point 70 in the same site. The installation ID is set, for example, at a timing when an administrator installs the touch point 70. For the touch point 70 that is portable, no installation ID is set and the corresponding field is blank. If the installation location of the touch point 70 is identified based on a usage status of a user, the installation ID is temporarily set automatically.

Further, the input content indicates information on a data file to be input to the device 90 or the like when using the coordination service 30 associated with the touch point 70, information on how to input content, or information on a terminal such as a smartphone or a camera used to use the coordination service 30. Further, the output destination indicates the service ID that identifies the coordination service 30 to identify the device 90, a cloud service, or the like as a destination to which the service to be used output content. The output content indicates information on output content that is output when the coordination service 30 associated with the touch point 70 is used.

In the example of FIG. 11, the touch point 70 whose touch point ID is “TpPrint1” is installed in the laboratory A, and a user who reads this touch point uses a service that prints a designated file in cooperation with a cloud print service (service ID: S002). The touch point 70 whose touch point ID is “TpAttend1” is installed in the lecture room A, and a user who reads this touch point uses a service that manages attendance to a teacher according to a lecture schedule in cooperation with an attendance management service (service ID: S001).

The touch point 70 whose touch point ID is “TpPrj1” is installed in the laboratory A, and a user who reads this touch point uses a service that projects content using a projector (PJ) in cooperation with a device coordination service (service ID: S005). The touch point 70 whose touch point ID is “TpPrj2” is a nonportable touch point, and a user who reads this touch point uses a service that projects content using a projector (PJ) in cooperation with the device coordination service (service ID: S005).

The touch point 70 whose touch point ID is “TpBoard1” is installed in the lecture room B, and a user who reads this touch point uses a service that stores an image file obtained by photographing content on a whiteboard in the lecture room in a cloud storage in cooperation with a cloud storage service (service ID: S004). The touch point 70 whose touch point ID is “TpSub1” is a nonportable touch point, and a user who reads this touch point uses a service that allows the user to submit an answer sheet in cooperation with a data submission service (service ID: S003). The above-described types of the touch point 70 and types of the coordination service 30 associated with the touch point 70 are merely examples. Any other suitable types of the touch point and types of the coordination service 30 can be appropriately set according to an environment of a site of a type of a site, for example.

Log Information Management Table:

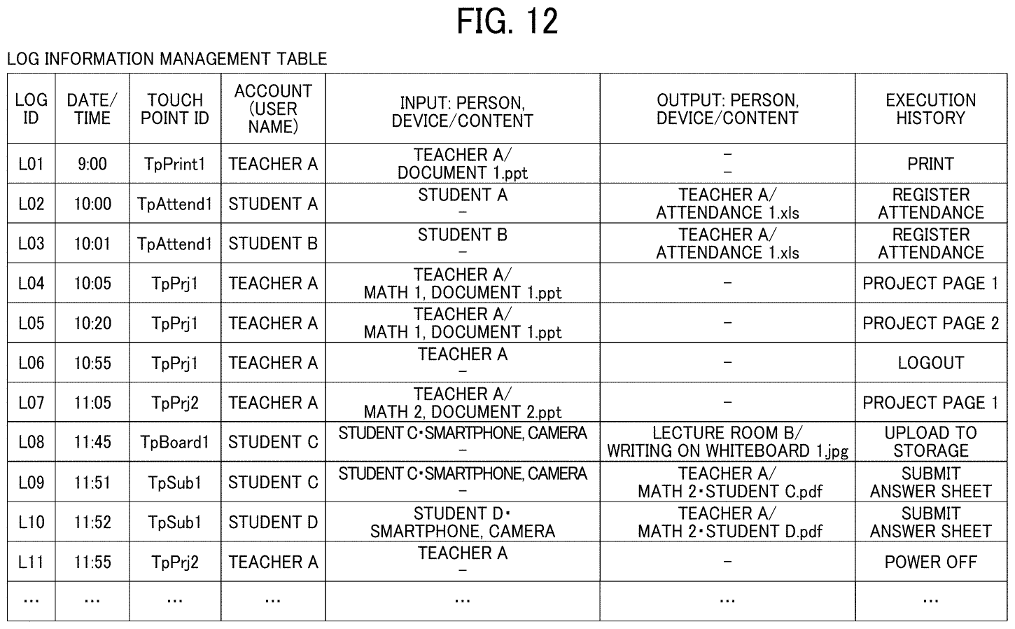

FIG. 12 is a conceptual diagram illustrating an example of a log information management table. In the storage unit 1000, a log information management DB 1003 is stored, for example, in the form of the log information management table as illustrated in FIG. 12, the log information management table indicating a usage history of a service used by a user who reads the touch point 70.

The log information management table manages log information in which a log ID, a date and time when the log was acquired, a touch point ID, account information, input information of a used service, and output information of the used service, and an execution history of the service are associated with each other. The log ID identifies a log. The touch point ID identifies the touch point 70. The account information identifies a user who has read the touch point 70.

The log ID is an ID issued in sequence and assigned to the usage history of a service used via the touch point 70 that is read. The log ID is an example of usage history identification information identifying a usage history of a service. The date and time indicates a date and time when a service is used via the touch point 70. Although the date and time is actually a combination of date and time, the date is omitted, in order to simplify the figure. The account information indicates a user name as account information identifying a user who has read the touch point 70. In another example, the account information may be an ID unique to the user or a mail address of the user. The account information is an example of user identification information.

The input information indicates meta information of input content to a service used via the touch point 70. The input information includes, for example, a person who inputs the input content, an input device, or the input content (e.g., a file name). The output information indicates meta information of output content from a service used via the touch point 70. The output information includes, for example, a person who receives the output content, an output device, or the output content (e.g., a file name). The content of the meta information included in each of the input information and the output information is an example of the attribute items included in log information. Further, the execution history indicates action information based on which usage content of the service can be identified. The execution history indicates an action history corresponding to content of the service that is provided via the touch point 70. Examples of the action history include printing, attendance registration, projection, uploading to storage, and submission of an answer sheet.

Functional Configuration of User Terminal:

Referring again to FIG. 9, a functional configuration of the user terminal 50 is described. The user terminal 50 includes a browser unit 51, a touch point read unit 52, a reception unit 53, a display control unit 54, and a storing/reading unit 59. These units are functions or means implemented by or that are caused to function by operating any of the hardware elements illustrated in FIG. 8 in cooperation with instructions of the CPU 501 according to the program for the user terminal 50 expanded to the RAM 503 from the EEPROM 504. The user terminal 50 further includes a storage unit 5000 implemented by the ROM 502 or the storage medium 508 illustrated in FIG. 8.

The browser unit 51 is mainly implemented by processing of the CPU 501 and is implemented by a general-purpose web browser. The touch point read unit 52, which is mainly implemented by processing of the CPU 501, reads the touch point 70 and activates the browser unit 51. For example, when the touch point 70 is an image of a two-dimensional code, the touch point read unit 52 reads the touch point 70 by capturing the image. When the touch point 70 is an information medium that reads information using short-range communications by an NFC tag or an RFID tag, the touch point read unit 52 reads the touch point 70 by reading the information by short-range communications, for example. When the touch point 70 is a communication device that transmits information using near-distance wireless communications such as Bluetooth® or ultrasonic waves, the touch point read unit 52 reads the touch point 70 by receiving the information by a short-range wireless communication network, for example.

The reception unit 53, which is mainly implemented by processing of the CPU 501, receives various selections or inputs from the user. The display control unit 54, which is mainly implemented by processing of the CPU 501, controls a display unit such as the display 518 to display various screens.

The storing/reading unit 59, which is mainly implemented by processing of the CPU 501, stores various data or information in the storage unit 5000 or reads various data or information from the storage unit 5000.

### Processes or Operation of Embodiment

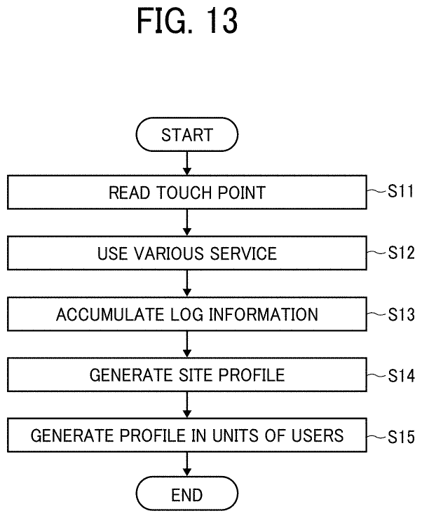

Referring to FIG. 13 to FIG. 25, processes and operations performed by the service use system 1 according to the embodiment is described. First, referring to FIG. 13, an overview of an entire flow of generating a profile by the service use system 1 is described. FIG. 13 is a flowchart illustrating an example of an operation of constructing a profile by the service use system 1.

First, the touch point read unit 52 of the user terminal 50 reads the touch point 70 attached to the device 90 or the like to acquire touch point information (step S11). The touch point information includes the touch point ID identifying the touch point 70. The user terminal 50 transmits the acquired touch point information to the information processing system 10, to use a predetermined service provided by the coordination service 30 corresponding to the read touch point 70 (step S12). The predetermined service includes the various services registered in the coordination service management DB 1001 illustrated in FIG. 10.

Further, the information processing system 10 accumulates and manages log information indicating a usage history of the predetermined service used via the user terminal 50 in the log information management DB 1003 (see FIG. 12) (step S13). Then, the information processing system 10 generates the site profile, which is a profile of a site including action histories of multiple users, by using the plurality of pieces of log information accumulated in step S13 (step S14). Further, the information processing system 10 generates a user profile, which is a profile indicating an action history on a user-by-use basis, by using user context information (step S15). A detailed description is now given of each of processes in the operation illustrated in FIG. 13.

Process for Using Service:

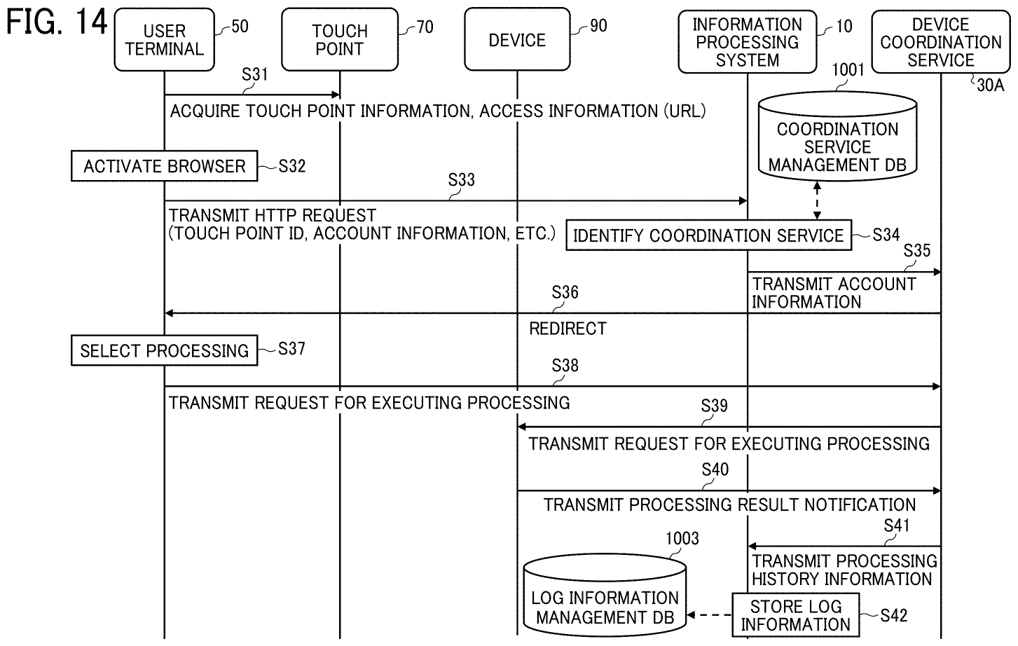

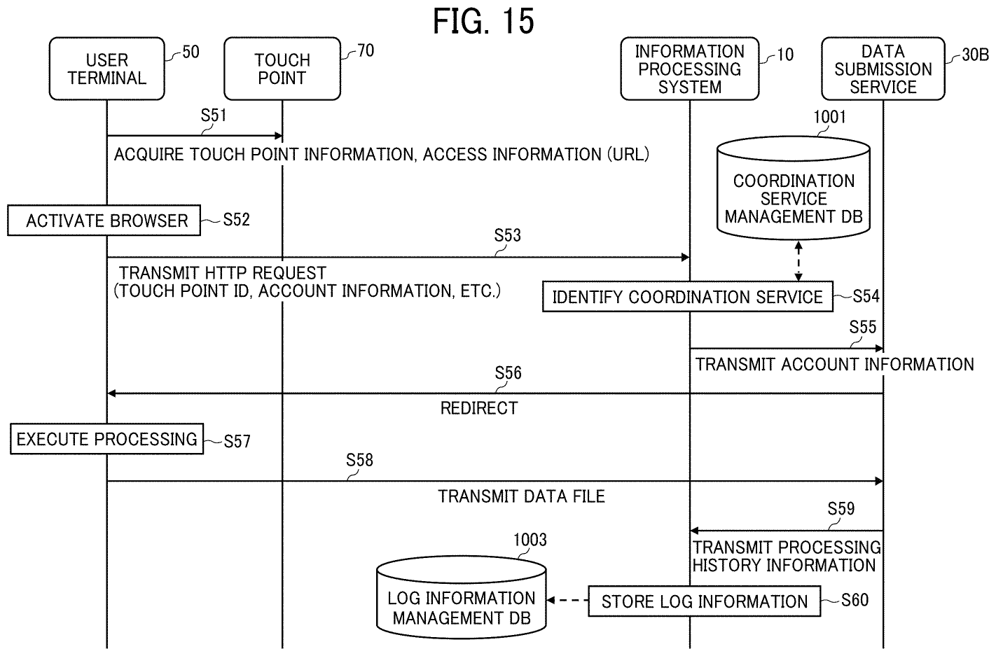

The processing of using a service provided through the touch point 70 in step S11 and step S12 of FIG. 13 are described in detail with reference to FIG. 14 and FIG. 15. FIG. 14 and FIG. 15 are sequence diagrams illustrating an example of the operation of using a service. First, referring to FIG. 14, a description is given of an example of an operation performed when a user reads the touch point 70 attached to the device 90 to use the device coordination service 30A (service ID; S005) using the device 90.

First, a user hangs the user terminal 50 close to the touch point 70 associated with the device 90 installed in the user environment and holds the user terminal 50 over the touch point 70 or photographs the touch point 70 to acquire the touch point information (step S31). The touch point information includes a touch point ID identifying the touch point 70 and access information indicating an access destination to be accessed by the user terminal 50 when the touch point 70 is read. The touch point information acquired in step S31 is an example of read information.

Then, the touch point read unit 52 of the user terminal 50 automatically activates the browser unit 51 with the access information included in the touch point information acquired in step S31 as an input (step S32). Then, the browser unit 51 of the user terminal 50 transmits a Hyper Text Transfer Protocol (HTTP) request to the access destination (information processing system 10) indicated by the access information acquired in step S31 (step S33). This HTTP request includes, for example, the touch point ID included in the touch point information acquired in step S31 and account information identifying the user. The account information is, for example, a cookie stored in association with the access information in the user terminal 50 when the user terminal 50 accesses the access destination in the past. In another example, the account information may be input by the user when the touch point 70 is read. In still another example, the user is temporarily permitted to log in as a guest, who does not need to enter account information, and the user is requested to enter the account information thereafter. The account information includes, for example, student information or employee information. Thus, the transmission/reception unit 11 of the information processing system 10, which is the access destination, receives the HTTP request transmitted from the user terminal 50.

Next, the identifying unit 13 searches the coordination service management DB 1001 (see FIG. 10) using the touch point ID received in step S33 as a search key, to read the coordination service information associated with the received touch point ID, thereby identifying a particular coordination service 30 (step S34). In the following, a description is given of an example in which the identifying unit 13 identifies the device coordination service 30A as the particular coordination service 30.

Next, the service providing unit 12 transmits the account information received in step S34 to the URL corresponding to the coordination service 30 identified in step S33 (step S35). Specifically, the service providing unit 12 transmits the account information to the URL (device coordination service 30A) included in the coordination service information read from the coordination service management DB 1001. Then, the device coordination service 30A performs user authentication using the account information transmitted from the information processing system 10 and performs redirection to the received account information to the user terminal 50, which is the request source (step S36).

Next, the browser unit 51 of the user terminal 50 selects a process relating to the predetermined service based on the information transmitted from the device coordination service 30A in step S36 (step S37). For example, the user terminal 50 displays a service use screen based on the information transmitted from the device coordination service 30A, and selects processing corresponding to a user's operation that is input to the displayed service use screen. Then, the browser unit 51 of the user terminal 50 transmits, to the device coordination service 30A, a processing request that requests execution of the processing selected in step S37 (step S38). This processing request includes, for example, a content of the requested processing and an input content (e.g., a data file) to be processed. The device coordination service 30A transmits the processing request transmitted from the user terminal 50 to the device 90 (step S39).

Next, the device 90 executes processing corresponding to the processing request received in step S39, and transmits a processing result notification indicating a result of the executed processing to the device coordination service 30A (step S40). This processing result notification includes the input content to be processed received in step S39 or an output content (e.g., a data file), which is the processing result. The communication between the device coordination service 30A and the device 90 in step S39 and step S40 may be performed via a relay device such as a gateway.

Next, the device coordination service 30A transmits, to the information processing system 10, processing history information indicating information included in the processing result notification received in step S40 (step S41). Thus, the service providing unit 12 of the information processing system 10 receives the processing history information transmitted from the device coordination service 30A. Then, the log management unit 14 stores the log information that associates the touch point ID and the account information received in step S33 with the processing history information received in step S41 in the log information management DB 1003 (see FIG. 12) via the storing/reading unit 19 (step S42).

With the processes described above, the service use system 1 allows the user to use a service that uses the device 90, the service being provided from the device coordination service 30A, which is an example of the coordination service 30, based on the touch point information read by the user terminal 50. Further, the information processing system 10 manages the log information in which the usage history of the service using the device 90 via the touch point 70 is associated with the read touch point 70 and the user who has read the touch point 70.

First, referring to FIG. 15, a description is given of an example of an operation performed when a user reads the touch point 70 installed in, for example, a user site, to use the data submission service 30B (service ID; S003). The processes of step S51 to S54 are performed in the same or substantially the same manner as the processes of S31 to S34 described with reference to FIG. 14, and redundant descriptions thereof are omitted below. In the following, a description is given of an example in which the identifying unit 13 identifies the data submission service 30B as the particular coordination service 30 in step S54.

In step S55, the service providing unit 12 transmits the account information received in step S54 to the URL corresponding to the coordination service 30 identified in step S53. Specifically, the service providing unit 12 transmits the account information to the URL (data submission service 30B) included in the coordination service information read from the coordination service management DB 1001. Then, the data submission service 30B performs user authentication using the account information transmitted from the information processing system 10 and performs redirection to the received account information to the user terminal 50, which is the request source (step S56).

Next, the browser unit 51 of the user terminal 50 selects a process relating to the predetermined service based on the information transmitted from the data submission service 30B in step S56 (step S57). For example, the user terminal 50 displays a service use screen based on the information transmitted from the data submission service 30B, and selects processing corresponding to a user's operation that is input to the displayed service use screen. Then, the browser unit 51 of the user terminal 50 transmits data file selected in step S57 to the data submission service 30B (step S58).

Next, the data submission service 30B stores the data file received in step S58 in a predetermined folder, and transmits processing history information including the data file received in step S58 to the information processing system 10 (step S59). Thus, the service providing unit 12 of the information processing system 10 receives the processing history information transmitted from the data submission service 30B. Then, the log management unit 14 stores the log information that associates the touch point ID and the account information received in step S53 with the processing history information received in step S59 in the log information management DB 1003 (see FIG. 12) via the storing/reading unit 19 (step S60).

Thus, the service use system 1 allows the user to use a cloud service provided by the data submission service 30B, which is an example of the coordination service 30, based on the touch point information read by the user terminal 50. Further, the information processing system 10 manages the log information in which the usage history of the cloud service that is used via the touch point 70 is associated with the read touch point 70 and the user who has read the touch point 70.

The processes described with reference to FIG. 14 are merely examples of processes performed when the service using the device 90 is used. The processes described with reference to FIG. 15 are merely examples of processes performed when the cloud service is used. The same or substantially the same process are performed on the coordination service 30 other than the device coordination service 30A and the data submission service 30B.

Site Profile Generation:

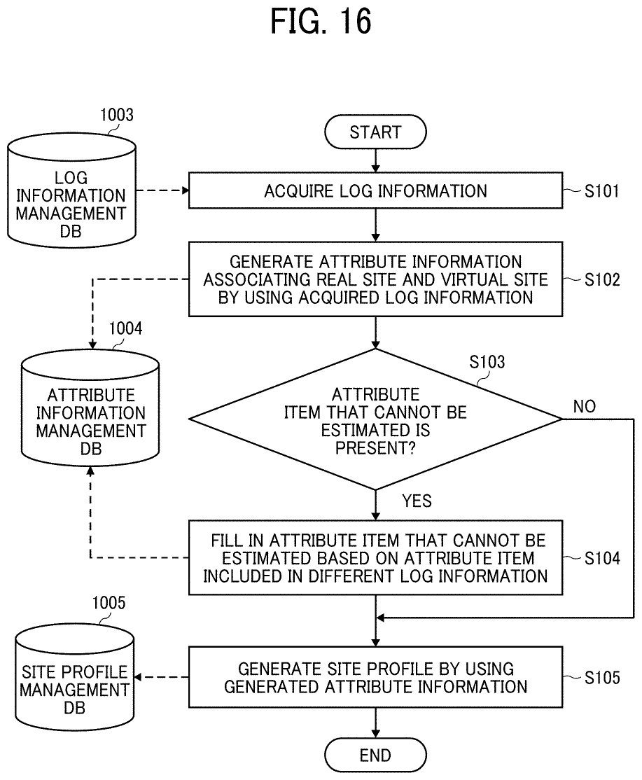

The processing of generating the site profile in step S13 and step S14 of FIG. 13 is described in detail with reference to FIG. 16 to FIG. 22. FIG. 16 is a flowchart illustrating an example of an operation of generating of a site profile by the information processing system 10.

First, the log management unit 14 of the information processing system 10 reads the log information stored in the log information management DB 1003 (see FIG. 12) via the storing/reading unit 19, to acquire the log information (step S101). Next, the estimation unit 15 of the information processing system 10 generates attribute information in which the real site and the virtual site are associated with each other by using the log information acquired in step S101 (step S102).

In the embodiment, the attribute information is information obtained by classifying content of the log information indicating the usage history of services accumulated in the log information management DB 1003 (see FIG. 12) into the attribute items indicating content of an action history of a user. Based on the attribute information, the action histories of multiple users at a site in the user environment are identified from the log information. In this case, the content of the action history of the user includes information of a real site where a user has used a service and information of a virtual site indicating a connection (connection between persons) between the users based on the action of the user in the real site by the use of the service by the user. The estimation unit 15 determines an actual physical movement of a person and a connection between persons in the virtual site associated with the moved person, and classifies the action history of the user in units of “the site changes” and “the connection between persons changes”. In other words, the real site indicates a physical movement of a user who has read the touch point 70 based on which a particular location is identified. The virtual site indicates a connection such as an exchange of data between persons associated with the real site at the same time.

Referring to an example of the log information illustrated in FIG. 12, a classification procedure of the attribute items is described. First, information on locations where the touch points 70 read by the teacher indicates that the real site corresponding to the log ID “L01” is different from the real site corresponding to the log IDs “L04” to “L06”. Further, the output information corresponding to the log ID “L02” and “L03” indicates that the student A, a student B, and the teacher A are present in the same site for the log IDs “L04” to “L06”. Furthermore, the log information management table illustrated in FIG. 12 indicates that the teacher A uses a nonportable projector in the period of the log IDs “L07” to “L11”. Still further, the record corresponding to the log ID “L08” indicates that the student C photographed content on the whiteboard in the lecture room B and uploaded data obtained by photographing to a storage. Still further, the record corresponding to the log ID “L09” indicates that the student C submitted a data file to the teacher A, and the record corresponding to the log ID “L10” indicates that a student D submitted a data file to the teacher A. The estimation unit 15 classifies the attribute items from the above results estimated from the acquired log information, to generate the attribute information. Then, the estimation unit 15 stores the generated attribute information in the attribute information management DB 1004 via the storing/reading unit 19.

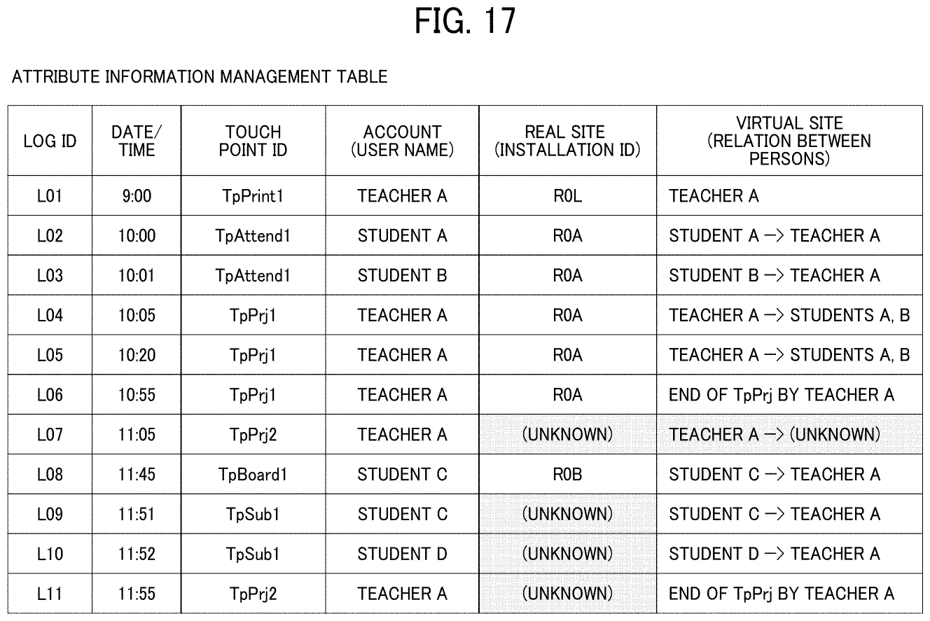

FIG. 17 is a conceptual diagram illustrating an example of an attribute information management table. The attribute information management table is a table for managing the attribute information generated by the estimation unit 15. In the storage unit 1000, an attribute information management DB 1004 is stored, for example, in the form of the attribute information management table as illustrated in FIG. 17.

The attribute information management table manages history information that associates a log ID, a date and time when the log is acquired, a touch point ID, account information, information on a real site where the user has used a service, and information on a virtual site with each another. The log ID identifies a log. The touch point ID identifies the touch point 70. The account information identifies a user who has read the touch point 70. The information on the virtual site is based on an action by the user in the real site by the use of the service.

The log ID, the date and time, the touch point ID, and the account information in the attribute information management table are the same as the contents of the log information (see FIG. 12) used by the estimation unit 15 to generate the attribute information. The information on the real site indicates the installation ID indicating an installation location where the read touch point 70 is installed, as a location where the user has used the service. Further, the information on the virtual site indicates a connection between users (connection between persons) based on an action by the user in the real site.

Next, the determination unit 17 of the information processing system 10 determines whether the attribute information generated in step S102 includes an attribute item that cannot be estimated (step S103). In the attribute information illustrated in FIG. 17, for the log ID “L07”, the real site and a user who views content projected by the projector according to the teacher A's operation cannot be estimated by the above-described processing by the estimation unit 15. Accordingly, the information on the real site and one user in the information on the virtual site are the attribute items that cannot be estimated. Further, for the log IDs “L09”, “L10”, and “L11”, the information on the real site cannot be estimated by the above-described processing by the estimation unit 15. Accordingly, the information on the real site is the attribute item that cannot be estimated. When the determination unit 17 determines that the attribute information includes an attribute item that cannot be estimated (YES in step S103), the operation proceeds to step S104. By contrast, when the determination unit 17 determines that the attribute information includes no attribute item that cannot be estimated (NO in step S103), the operation proceeds to step S105.

Next, the estimation unit 15 of the information processing system 10 fills in the attribute items that are identified as attribute items that cannot be estimated in step S101, based on attribute items included in the plurality of pieces of log information acquired in step S103 (step S104). Specifically, the estimation unit 15 fills in an unknown attribute item that cannot be estimated included in a certain piece of log information based on a known attribute item included in the log information and a known attribute item included in other pieces of log information.

For example, the information on the virtual site in the log information identified by the log ID “L08” indicates that there is a connection between the student C and the teacher A. Accordingly, the estimation unit 15 fills in the information on the real site in the log information identified by the log IDs “L07” and “L11”, which are attribute items that cannot be estimated, with “R0B (lecture room B)”, which is the same as the information on the real site in the log information identified by the log ID “L08”. The log information identified by the log IDs “L07” and “L11” is an example of first log information. The log information identified by the log ID “L08” is an example of second log information. The device coordination service associated with the touch point ID “TpPrj2” corresponding to the log IDs “L07” and “L11” is an example of a first service. The cloud storage service associated with the touch point ID “TpBoard1” corresponding to the log ID “L08” is an example of a second service. Further, the information on the virtual site in the log information identified by the log ID “L09” indicates that there is a connection between the student C and the teacher A, and the information on the virtual site in the log information identified by the log ID “L10” indicates that there is a connection between the student D and the teacher A. Accordingly, the estimation unit 15 fills in the one user in the information on the virtual site in the log information identified by the log ID “L07”, which is an attribute items that cannot be estimated, with “student C, student B”, who are the users in the log information identified by the log IDs “L09” and “L10”. Furthermore, the information on the virtual site in the log information identified by the log ID “L07”, which is added for complement as described above, indicates that there is a connection among the student C, the student B, and the teacher A, and the information on the real site in the log information identified by the log ID “L07”, which is added for complement as described above, indicates that “R0B (lecture room B)” is the real site. Accordingly, the estimation unit 15 fills in the information on the real site in the log information identified by the log IDs “L09” and “L10”, which are attribute items that cannot be estimated, with “R0B (lecture room B)”, which is the same as the information on the real site in the log information identified by the log ID “L07”.

Next, the generation unit 16 generates a site profile including action histories of a plurality of users by using the attribute information generated in step S102 and the attribute information complemented in step S104 (step S105). Then, the generation unit 16 stores the generated site profile in the site profile management DB 1005 via the storing/reading unit 19.

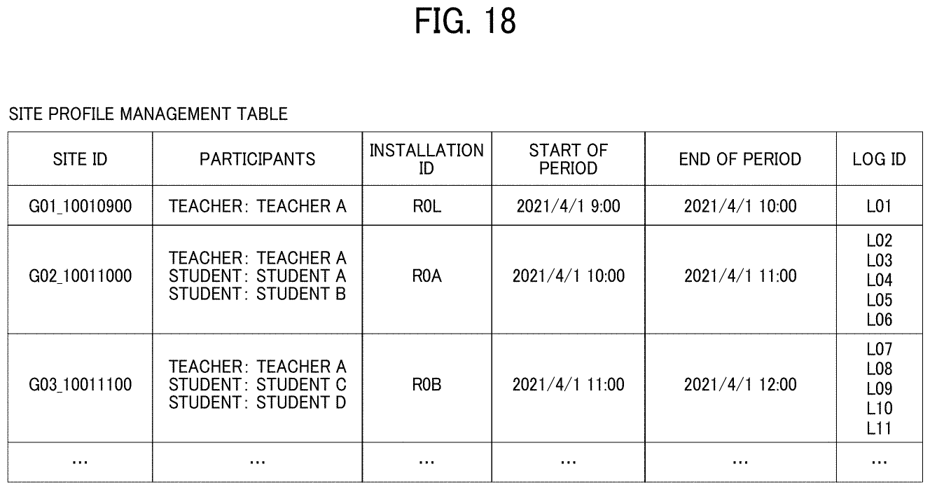

FIG. 18 is a conceptual diagram illustrating an example of a site profile management table. The site profile management table is a table for managing the site profile generated by the generation unit 16. In the storage unit 1000, a site profile management DB 1005 is stored, for example, in the form of the site profile management table as illustrated in FIG. 18.

The site profile management table manages a site profile that associates a site ID, participants, an installation ID of the touch point 70, and a log ID with each other. The site ID identifies a site in the user environment. The participants indicate persons who participate in a predetermined action performed in the site. The installation ID of the touch point 70 indicates a location of the site. The start of period and the end of period indicate a period during which the action is performed in the site. The log ID identifies log information used for generation of the site profile.

The site profile may be generated in advance based on a schedule or a plan, for example. Alternatively, the site profile is generated by classifying the action histories based on the above-described processing. The generation unit 16 generates or supplements a content of the site profile that has not been generated in advance, by classifying the action histories using the accumulated log information. The information processing system 10 generates the site profile using the plurality of pieces of log information, to merge the real site and the virtual site, and thus integrates action histories of a plurality of users, the action histories being fragmentary.

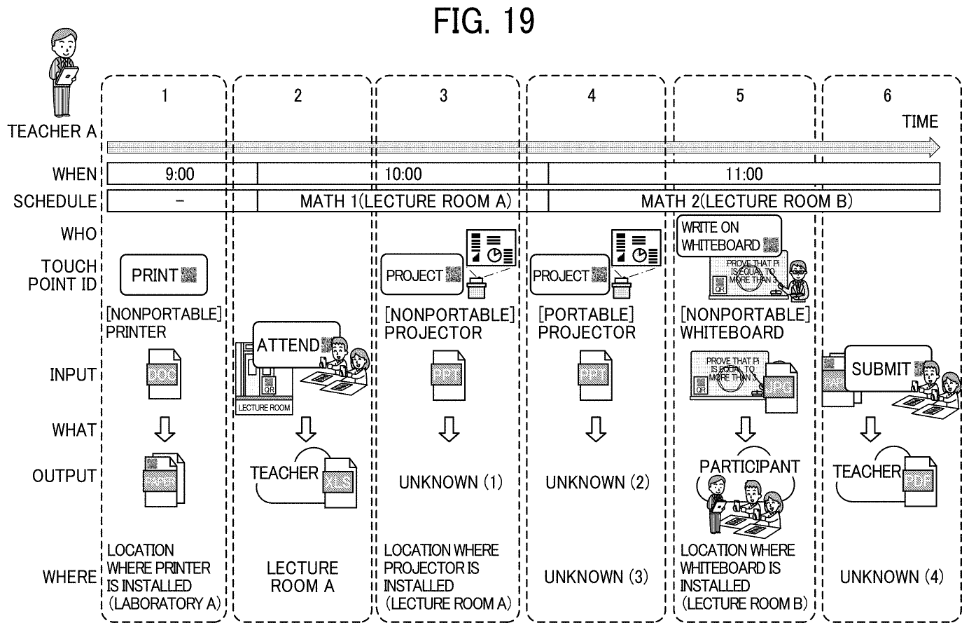

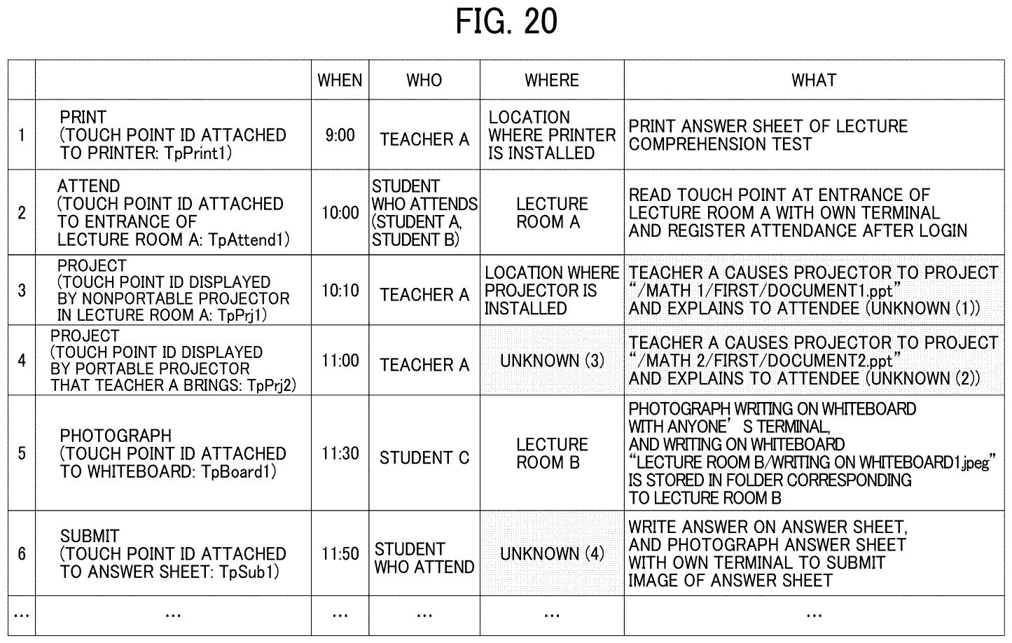

Referring to FIG. 19 to FIG. 22, an overview of generation of the site profile is described. FIG. 19 and FIG. 20 are diagrams for describing an overview of an example of an action history in which the teacher A is set as a starting point. FIG. 19 illustrates a journey map in which the teacher A is set as a starting point. FIG. 20 illustrates details of an action history of each point in FIG. 19.

As illustrated in FIG. 19, the information processing system 10 integrates action histories, which are fragmentary, at a site, based on use histories of services used via different touch points 70. The use of the touch points 70 that are arranged in the site, which is a user environment, is effective to acquire a time-series action history along a person's movement line at the site. The service use system 1 arranges the touch points 70 along the movement lines of a plurality of users at a real site, to acquire an action history indicating when, who, where, and what. For example, the teacher A prints in the laboratory A, gives a lecture in the lecture room A, and gives a lecture in the lecture room B along a movement line for giving a lecture to students.

As processing corresponding to the above-described step S102, the information processing system 10 estimates an action history for each point (1 to 6) in actions at the site while classifying the action history into attribute items, based on the log information corresponding to the read touch point 70. The attribute items include items of when, who, where, and what (to whom). On the other hand, as illustrated in FIG. 20, in the action of the teacher A, although a fragmentary action history is estimated from the usage history of individual services, some attribute items cannot be estimated only by understanding the journey map of the teacher A. In the examples of FIG. 19 and FIG. 20, the information processing system 10 cannot estimate the attribute item of “to whom” (“unknown (1)”) of the point 3, the attribute items of “to whom” (“unknown (2)”) and “where” (“unknown (3)”) of the point 4, and the attribute item of “where” (“unknown (4)”) of the point 6.

As processing corresponding to the above-described step S104, the information processing system 10 fills in the attribute items that cannot be estimated. For example, regarding the attribute item “to whom” (“unknown (1)”) of the point 3, the information processing system 10 identifies a person who views the nonportable projector. In the example, attendees of the lecture are identified based on information that the student A and the student B perform attendance registration (the point 2) using the touch point 70 at the entrance of the lecture room A. Thus, the information processing system 10 identifies the student A and the student B as the persons who view the nonportable projector, and fills in the attribute item that cannot be estimated with the student A and the student B. Further, regarding the attribute item “to whom” (“unknown (2)”) of the point 4, the information processing system 10 identifies a person who views the portable projector. Specifically, the information processing system 10 regards a submitter of an answer sheet during the lecture as an attendee of the lecture, and thus identifies the student C and the student D as the person who views the portable projector and fills in the attribute item that cannot be estimated with the student C and the student D.

Further, regarding the attribute item “where” (“unknown (3)”) of the point 4, the non-stationary portable projector is available for operation for a certain period of time (e.g., one hour) from the start of the operation, and is continuously available for operation until an instruction for turning off the power or an instruction for ending the use is input. In view of such the configuration of the nonportable projector, the information processing system 10 identifies a location for submission (the point 6) based on information on a submission item indicating that an answer sheet was submitted around the same time. Further, based on information that the same student (student C) as the student who submitted the answer sheet around the same time photographed content on the whiteboard and submitted the photograph to the teacher A (the point 5), the information processing system 10 identifies the location of the point 6 as the location of teacher A and fills in the attribute item that cannot be estimated with the location of the point A. Thus, based on the usage history of different touch points 70 by the same user around the same time, the information processing system 10 fills in an attribute item that cannot be estimated in another usage history.

Further, regarding the attribute item “where” (“unknown (4)”) of the point 6, in a case that a student submits an answer sheet via the touch point 70 attached to the answer sheet, the student can submit the answer sheet from anywhere from the user terminal 50 of the student. This means that a location cannot be identified based on one usage history. In view of such issue, the information processing system 10 identifies the location where the submission is performed based on the different usage history (the point 4) of the teacher A, who is a submission destination. When the location of the teacher is determined at the lecture time of the submission destination, the information processing system 10 estimates that the submission is performed in the lecture room if the submission is performed during the lecture time.

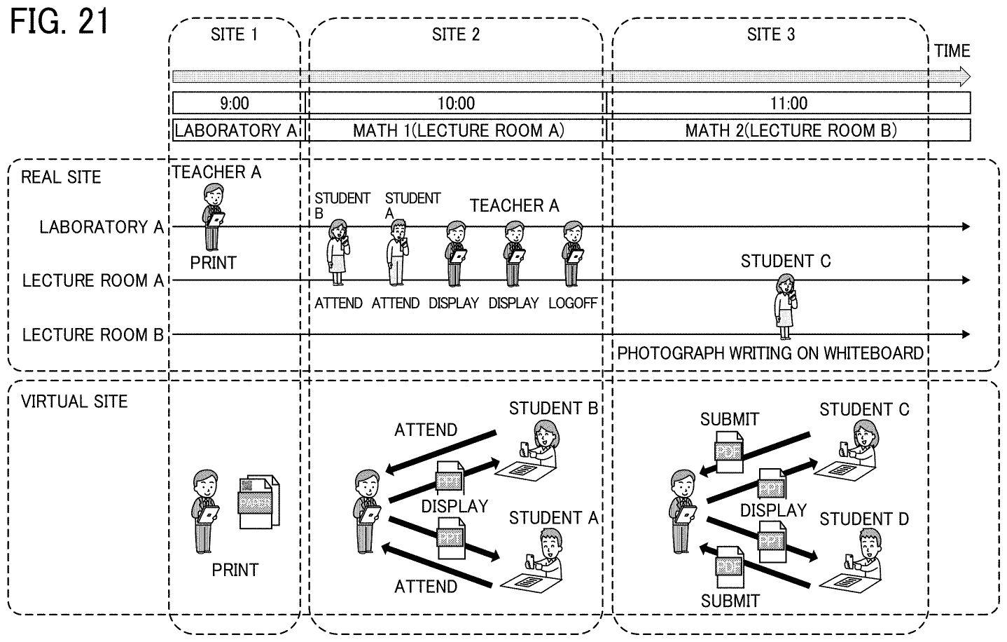

FIG. 21 is a diagram for describing an overview of an example of a site profile generated with the teacher A as a starting point. FIG. 21 illustrates an action history in which the teacher A is set as a starting point, the action history being separated into the real site and the virtual site. The real site indicates a physical movement for the users who have read the touch points 70 whose location are identifiable (including the installation IDs). The virtual site indicates exchange of data between persons associated with the real site at the same time. The site profile is a profile of a site obtained by integrating fragmentary action histories by merging the real site and the virtual site.

As described above, the information processing system 10 estimates an unknown attribute item based on a certain usage history based on the usage history of different services provided via the touch points 70, and thus generates the site profile indicating the action histories at the site where the services are used. Further, the information processing system 10 generates the site profile by using usage histories of different services provided via the touch points 70, and thus can recognize cross-sectional action histories at the site from fragmentary usage histories of the services. Furthermore, the information processing system 10 accumulates the usage histories of the services provided via the touch points 70 installed in view of a movement line of a person at the site, and thus can implement more clear estimation of the action history of the user at the site.

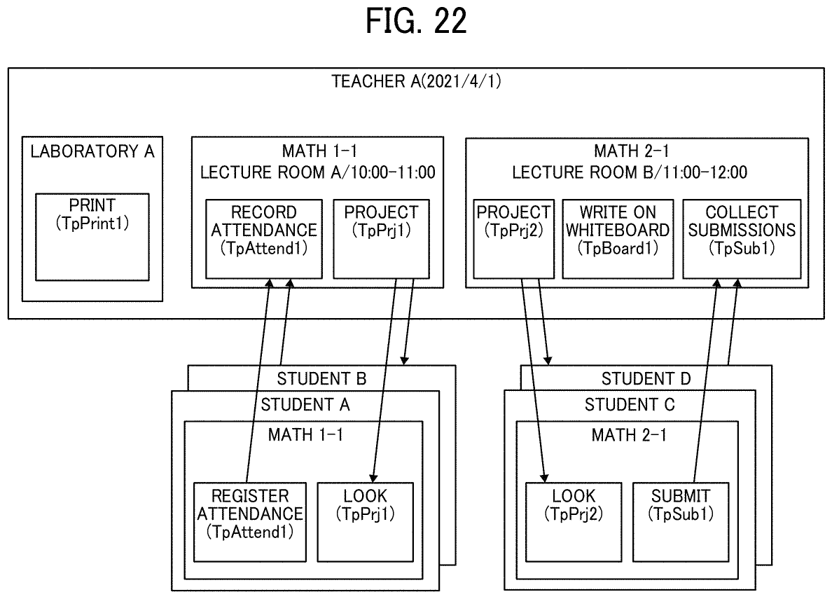

FIG. 22 is a diagram for describing an overview of an example of a user profile generated with the teacher A as a starting point. The information processing system 10 constructs the site profile as a profile from a user's point of view, and thus can construct the user profile, which is a profile on a user-by-user basis, in step S15 of FIG. 13. For example, the user profile stores multiple site profiles, which are different action histories performed at the site. Further, the user profile may add meta information of the site based on context information such as a user's schedule or a user's plan and map the meta information.

As illustrated in FIG. 22, the action histories at the site are associated with the touch points 70 (the touch point IDs). The time-series action history of a person at a site along the movement line is constructed as the site profile, by grouping services centered on the exchange of content between persons using the touch point 70 on a site-by-site basis by the above-described estimation processing with a person as a starting point. In the site of the laboratory A, the math 1-1 illustrated in FIG. 22, multiple touch points 70 (the touch point IDs) used by a user (the teacher A) are stored. The units of the site can be grouped based on the action history at the site, and are classified according to a change of the site, or a change of a connections between persons, for example. Further, the touch point ID holds information on the touch point 70 read by a user. Since the service provided via the touch point 70 is a service that connects persons, when a user reads the touch point by himself/herself, the service is managed as transmission, and content of a service used by another user by reading the touch point 70 is managed as reception.

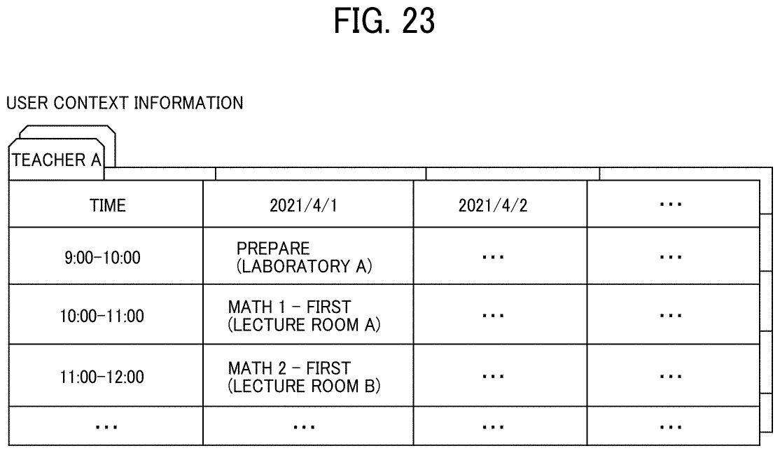

FIG. 23 is a diagram illustrating an example of the user context information. FIG. 23 illustrates information indicating a schedule of the teacher A. The information processing system 10 shares the user context information with an external scheduler system, for example, and thus acquires the user context information. The information processing system 10 can classify the action history more clearly by adding the context information for each user to the site profile. In the example of FIG. 23, by adding the context information of the teacher A, the information processing system 10 associates Math 1-1, which is a lecture content in the lecture room A at the corresponding time, and thus can clarify a range of a period in a location at the site. Although the description given above is of an example in which the information processing system 10 adds the user's schedule as the context information, the user's schedule is merely one example. In another example, the information processing system 10 adds, for example, reservation information of a location or a lecture schedule for each lecture room, and thus can further clarify the classification of the action history.

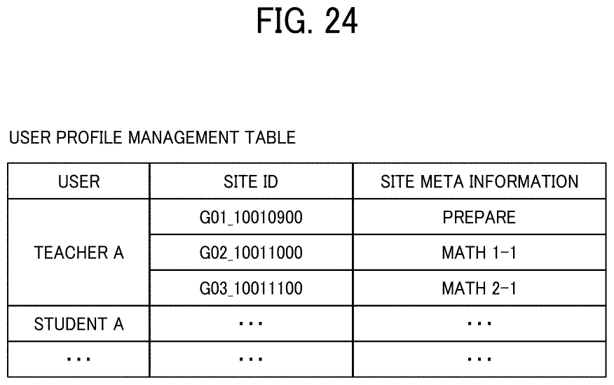

FIG. 24 is a conceptual diagram illustrating an example of a user profile management table. The user profile management table is a table for managing the user profile generated by the generation unit 16. In the storage unit 1000, a user profile management DB 1006 is stored, for example, in the form of the user profile management table as illustrated in FIG. 24.

The user profile management table manages, for each user, a user profile that associates a site ID for identifying a site in a user environment with meta information of the site. The meta information of the site is added based on the content of the user context information as illustrated in FIG. 23.

Thus, the information processing system 10 generates a more clarified profile for each user by adding the user context information to the site profile in which the action histories are classified in the above-described processing.

Statistical Processing Based on Profile:

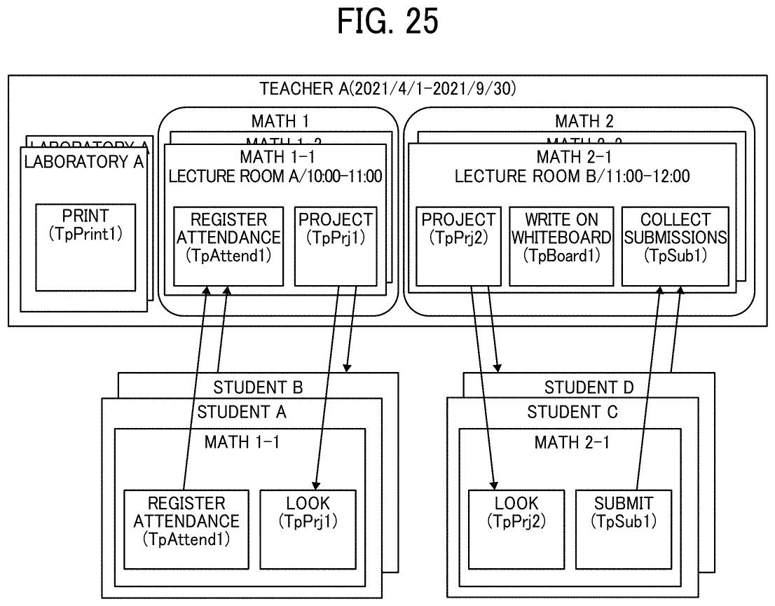

Referring to FIG. 25, an example of statistical processing in which the site profile and the user profile generated in the above-described processing are accumulated. FIG. 25 is a diagram for describing an overview of an example of a course period profile in which the teacher A is set as a starting point. The information processing system 10 accumulates daily site profiles and user profiles and integrates the profiles in a predetermined time period, to implement business statistics. FIG. 25 illustrates an example of a course period profile generated by integrating profiles of the teacher A for the periods from Apr. 1, 2021 to Sep. 30, 2021.

The information processing system 10 integrates profiles for a predetermined period, and thus can perform statistics such as the number of times of reading of the touch point 70, the number of users who have read the touch point 70, or the location where the touch point 70 is read. Thus, the information processing system 10 manages the user profiles that sets a user as a starting point and is based on the site profile, and thus can integrate the fragmented data. With this configuration, the information processing system 10 can more clearly identify users who has used the services in addition to the number of users who has read the touch point 70.

Further, for example, the information processing system 10 constructs a profile in which a user who has read the touch point 70 is set as a starting point, and thus can perform statistics on the connection between a sender of the touch point ID and a receiver of the touch point ID for each site. Thus, the information processing system 10 can integrate the profiles for the predetermined period to perform statistics on the connection between persons associated with the touch point 70 (the touch point ID). Furthermore, for example, the information processing system 10 constructs a profile in which a user who has read the touch point 70 is set as a starting point, and thus can perform statistics on the usage of the services for each site. Thus, the information processing system 10 can integrate the profiles for the predetermined period to perform statistics on the connection between a person and a service associated with the touch point 70 (the touch point ID).

Furthermore, since the information processing system 10 can manage the connection between the participants (the users) for each site, and thus can perform statistics using the user context information in addition to the exchange of content between persons. Thus, the information processing system 10 can integrate the profiles for the predetermined period and recognize, as metadata, the connection between a user and content associated with the touch point 70 (the touch point ID). Furthermore, for example, the information processing system 10 integrates the site profiles for a predetermined period, and thus can perform, for example, advertisement or guidance according to statistics between services provided via different touch points 70. With this configuration, the information processing system 10 can perform advertisement or recommendation according to an access status of a person associated with the touch point 70 (the touch point ID).

In the field of education such as schools as described in the present embodiment, there is a service called an “e-portfolio”, which converts learning at school is into data for each student. This service digitizes reports, examination papers, or moving images or photographs obtained by recording activities, which are produced by students during learning, and stores the digitized content. This service is used as a reference for teachers to evaluate students, or used by students themselves as their own learning. As an input to the service, in a case that learning is performed digitally, for example, through browsing a file or viewing a video, the service automatically stores the learning process. Further, a student himself/herself records his/her action or awareness at the real site as memos in his/her personal e-portfolio. By cooperating with the e-portfolio service, the information processing system 10 can improve the statistical accuracy of the profile in education and improve the quality of the service.

Further, the information processing system 10 can merge data of the real site and the virtual site by using the touch point 70 (the touch point ID), and thus can automatically store an action at the real site in the e-portfolio. With this configuration, the teacher can visualize the effect of the use of the device 90 on the lecture, for example. Specifically, the teacher can obtain statistics of comparison of a student's level of understanding between a lecture in which only a whiteboard is used, a lecture in which only a projector is used, and a lecture in which both the whiteboard and the projector are used. Further, the teacher can visualize a difference in setting preparation time between the use of the nonportable projector and the portable projector. Furthermore, the teacher can store, for example, writing on a whiteboard written during a lecture and a file projected by a projector in chronological order, and thus can make the lecture available online. Furthermore, for example, based on the statistics of the profiles, the teacher can predict attendees or find out the relation between the level of understanding of all students and the grade in the statistics of the submission, without checking the attendance.

On the other hand, each of students can also keep, as an action history for each student, the content of a file or writing on the whiteboard, the content being explained using a projector during a lecture. Further, the students can record attendance without attendance registration. Furthermore, the students can compare differences in their own grades between in a lecture in which only a whiteboard is used, a lecture in which only a projector is used, and a lecture in which both the whiteboard and the projector are used.

As described, the information processing system 10 performs the integration processing using the accumulated profiles, and thus allows a user to check the access status of data exchanged between persons from a cross-sectional viewpoint, with the touch point 70 (the touch point ID) that connects a person and a service as a starting point. Further, the information processing system 10 can associate metadata based on the touch point 70 (the touch point ID) with content (information) that is exchanged.

As described above, the service use system 1 estimates an unknown attribute item based on a certain usage history based on the usage history of different services provided via the touch points 70, and thus can generate the site profile indicating the action histories at the site where the services are used. Further, the service use system 1 generates the site profile by using usage histories of different services provided via the touch points 70, and thus can recognize cross-sectional action histories at the site from fragmentary usage histories of the services.

Furthermore, the service use system 1 accumulates the usage histories of the services provided via the touch points 70 installed in view of a movement line of a person at the site, and thus can implement more clear estimation of the action history of the user in at site. Furthermore, the service use system 1 performs statistical processing that integrates the accumulated site profiles and user profiles, and thus can effectively utilize the statistical result when providing a new service.

In the above description of the embodiment, a school is used as an example of the user environment in which the touch point 70 is set, but this is not limiting. Examples of the user environment in which the touch point 70 is set include an office, a factory, a warehouse, a work site where construction or inspection work is performed, a store, a commercial facility, a hospital, a nursing facility, public transportation, and a home. Also in the user environment as described above, the service use system 1 accumulates, in the information processing system 10, the log information corresponding to content of the coordination service 30, which is provided via the touch point 70, according to the target user environment and manages the accumulated log information. With this configuration, the service use system 1 can generate the site profile or the user profile corresponding to the usage histories of multiple services in the user environment.

In the related art, when one is going to utilize data of usage histories of various services that are provided via touch points, the one cannot recognize the relations of the usage histories between different services. Accordingly, the one cannot recognize in detail a usage scene at a site where the services are used.

According to one or more embodiment of the present disclosure, a profile of a site where a service is used is generated based on a usage history of multiple different services that are used through a touch point.

According to one or more embodiment, a non-transitory computer-executable medium storing a program storing instructions is provided, which, when executed by a computer, causes the computer to perform an information processing method. The information processing method includes acquiring log information that includes identification information identifying a touch point read by a user terminal and indicates a usage history of a particular service identified by the identification information, the log information including a plurality of log information. The information processing method includes estimating attribute information including a plurality of attribute items for identifying use of the particular service based on the plurality of log information. The information processing method includes generating a site profile indicating an action history at a site where the touch point is read based on the acquired log information and the estimated attribute information.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), systems on a chip (SOCs), graphics processing units (GPUs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Each of the tables of the above-described embodiments may be generated by learning effect of machine learning. In addition, in alternative to using the tables, the data of each related item may be classified by the machine learning. In the present disclosure, the machine learning is defined as a technology that makes a computer to acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for the machine learning, for example, any one of supervised learning, unsupervised learning, semi-supervised learning, reinforcement learning, and deep learning, or a combination of two or more of these learning.

Although the information processing system, the service use system, the information processing method, and the program according to one or more embodiments of the present disclosure have been described above, the above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing system, comprising circuitry configured to:
acquire a plurality of log information each including identification information identifying a touch point read by a user terminal and indicating a usage history of a particular service identified by the identification information;
estimate attribute information including a plurality of attribute items for identifying use of the particular service based on the plurality of log information; and
generate a site profile indicating an action history at a site where the touch point is read based on the plurality of log information and the estimated attribute information.

2. The information processing system of claim 1, wherein the circuitry fills in an unknown attribute item corresponding to first log information based on a known attribute item included in the first log information and a known attribute item included in second log information, to estimate the attribute information included in the first log information.

3. The information processing system of claim 1, wherein the plurality of attribute items includes information of at least one of a user who has used the particular service, a usage time, a usage location, or a service content.

4. The information processing system of claim 2, wherein
the unknown attribute item corresponding to the first log information is information on a location where a first service is used, and
the circuitry estimates the attribute information included in the first log information by filling in the information on the location where the first service is used, based on known attribute items including the known attribute item included in the first log information and the known attribute item including information on a location where a second service is used included in the second log information.

5. The information processing system of claim 2, wherein
the unknown attribute item corresponding to the first log information is information on a user who has used a first service, and
the circuitry estimates the attribute information included in the first log information by filling in the information on the user who has used the first service, based on known attribute items including the known attribute item included in the first log information and the known attribute item including information on a user who has used a second service included in the second log information.

6. The information processing system of claim 1, wherein the circuitry generates the site profile including action histories of a plurality of users who have read the touch point, based on the acquired plurality of log information and the estimated attribute information.

7. The information processing system of claim 1, wherein
the touch point includes a two-dimensional code, and
the information processing system further comprises a memory that stores each log information generated based on information acquired by the user terminal that reads the two-dimensional code.

8. A system, comprising:
an information processing system including information processing system circuitry; and
a user terminal including user terminal circuitry,
the user terminal circuitry being configured to
read a touch point, and
transmit, to the information processing system, information acquired by reading the touch point,
the information processing system circuitry being configured to
acquire a plurality of log information each including identification information identifying the touch point read by the user terminal and indicating a usage history of a particular service identified by the identification information,
estimate attribute information including a plurality of attribute items for identifying use of the particular service based on the plurality of log information,
generate a site profile indicating an action history at a site where the touch point is read based on the plurality of log information and the estimated attribute information, and
provide to the user terminal the particular service corresponding to the information acquired by reading the touch point.

9. An information processing method performed by an information processing system, the information processing method comprising:
acquiring a plurality of log information each including identification information identifying a touch point read by a user terminal and indicating a usage history of a particular service identified by the identification information;
estimating attribute information including a plurality of attribute items for identifying use of the particular service based on the plurality of log information; and
generating a site profile indicating an action history at a site where the touch point is read based on the acquired plurality of log information and the estimated attribute information.

10. The information processing method of claim 9, wherein
the estimating includes filling in an unknown attribute item corresponding to first log information based on a known attribute item included in the first log information and a known attribute item included in second log information, to estimate the attribute information included in first log information.

11. The information processing method of claim 9, wherein the plurality of attribute items includes information of at least one of a user who has used the particular service, a usage time, a usage location, or a service content.

12. The information processing method of claim 10, wherein
the unknown attribute item corresponding to the first log information is information on a location where a first service is used, and
the estimating includes estimating the attribute information included in the first log information by filling in the information on the location where the first service is used, based on known attribute items including the known attribute item included in the first log information and the known attribute item including information on a location where a second service is used included in the second log information.

13. The information processing method of claim 10, wherein
the unknown attribute item corresponding to the first log information is information on a user who has used a first service, and
the estimating includes estimating the attribute information included in the first log information by filling in the information on the user who has used the first service, based on known attribute items including the known attribute item included in the first log information and the known attribute item including information on a user who has used a second service included in the second log information.

14. The information processing method of claim 9, wherein the generating includes generating the site profile including action histories of a plurality of users who have read the touch point, based on the acquired plurality of log information and the estimated attribute information.

15. The information processing method of claim 9, wherein
the touch point includes a two-dimensional code, and
the information processing method further comprises storing, in a memory, each log information generated based on information acquired by the user terminal that reads the two-dimensional code.
